(19) United States
(12) Patent Application Publication
(10) Pub. No.: US 2014/0272698 A1
(43) Pub. Date: Sep. 18, 2014

(54) TONER

(71) Applicants: Masahide YAMADA, Shizuoka (JP); Atsushi Yamamoto, Osaka (JP); Satoyuki Sekiguchi, Shizuoka (JP); Keiji Makabe, Shizuoka (JP); Kohsuke Nagata, Shizuoka (JP); Toyoshi Sawada, Kanagawa (JP)

(72) Inventors: Masahide YAMADA, Shizuoka (JP); Atsushi Yamamoto, Osaka (JP); Satoyuki Sekiguchi, Shizuoka (JP); Keiji Makabe, Shizuoka (JP); Kohsuke Nagata, Shizuoka (JP); Toyoshi Sawada, Kanagawa (JP)

(21) Appl. No.: 14/210,993

(22) Filed: Mar. 14, 2014

(30) Foreign Application Priority Data
Mar. 15, 2013 (JP) 2013-052662
Jan. 16, 2014 (JP) 2014-005580

(51) Int. Cl. G03G 9/087

(52) U.S. Cl. CPC G03G 9/08764; G03G 9/08753; G03G 9/08702; G03G 9/08755
USPC 430/109.2; 430/109.1; 430/109.3; 430/109.4; 430/109.5

(57) ABSTRACT

Toner contains a binder resin containing two or more kinds of crystalline resins; and a coloring agent, wherein the two or more kinds of crystalline resins have at least two endothermic peak temperatures in a set of endothermic peak temperatures of the two or more kinds of crystalline resins as measured by differential scanning calorimetry (DSC).

### CROSS-REFERENCE TO RELATED APPLICATIONS

This patent application is based on and claims priority pursuant to 35 U.S.C. §119 to Japanese Patent Application Nos. 2013-052662 and 2014-005580 filed on Mar. 15, 2013 and Jan. 16, 2014, respectively, in the Japan Patent Office, the entire disclosures of which are hereby incorporated by reference herein.

### BACKGROUND

1. Technical Field

The present invention is related to toner.

2. Background Art

Technologies to fix toner at low temperatures have been demanded. That is, toner that can be fixed at low temperatures have been demanded.

Since such low temperature fixability of toner can be secured by reducing the melt viscosity thereof toner, binder resins have been used as toner binders. However, using such a binder resin arises a problem of hot offset due to shortage of elasticity at melt-fusing. In efforts to solve this problem, for example, JP-2007-147927-A and JP-2004-197051-A disclose methods of using combinations of crystalline resins and non-crystalline resins as toner binder (binder resin). JP-2012-27212-A, JP-2012-42939-A, JP-2012-42940-A, and JP-2012-42941-A disclose block copolymers of crystalline polyesters and non-crystalline polyesters. However, since the viscosity of such toner layer fixed on paper is excessively low, paper on which images are formed sticks together (so-called blocking problem) in continuous printing.

### SUMMARY

The present invention provides improved toner that contains a binder resin containing two or more kinds of crystalline resins; and a coloring agent, wherein the two or more kinds of crystalline resins have at least two endothermic peak temperatures in a set of endothermic peak temperatures of the two or more kinds of crystalline resins as measured by differential scanning calorimetry (DSC).

### DETAILED DESCRIPTION

The toner of the present disclosure is as follows:

1: Toner that contains a binder resin containing two or more kinds of crystalline resins and a coloring agent, wherein the two or more kinds of crystalline resins have at least two endothermic peak temperatures in a set of endothermic peak temperatures of the two or more kinds of crystalline resins as measured by differential scanning calorimetry (DSC).

2. The toner mentioned above, wherein the highest endothermic peak temperature and the lowest endothermic peak temperature of the set of endothermic peak temperatures has a difference of from 3° C. to 40° C.

3. The toner mentioned above, wherein each of the two or more kinds of crystalline resins has an endothermic peak temperature of from 40° C. to 120° C.

4. The toner mentioned above, wherein the two or more kinds of crystalline resins satisfy the following relation in measuring of viscoelasticity of a mixture of the two or more kinds of crystalline resins:

0° C.<Tup−Tdown≦30° C.,

where Tup represents a temperature at which the two or more kinds of crystalline resins have a storage elastic modulus of 1.0×10⁶ Pa at a temperature rising rate of 10° C./minute from 30° C. and Tdown represents a temperature at which the two or more kinds of crystalline resins have a storage elastic modulus of 1.0×10⁶ Pa at a temperature falling rate of 10° C./minute from a temperature of Tup+20° C.

5. The toner mentioned above, wherein at least one of the two or more kinds of crystalline resins is a resin containing a crystalline portion and a urethane bond.

6. The toner mentioned above, wherein at least one of the two or more kinds of crystalline resins is a resin containing a crystalline portion with no non-crystalline portion.

7. The toner mentioned above, wherein at least one of the two or more kinds of crystalline resins is a block resin containing a crystalline portion and a non-crystalline portion.

8. The toner mentioned above, wherein the content ratio of the crystalline portion is 50% by weight to 99% by weight based on the mass of the two or more kinds of crystalline resins.

9. The toner mentioned above, wherein the crystalline portion is derived from a resin selected from the group consisting of a crystalline polyeyster resin, a crystalline polyurethane resin, a crystalline polyurea resin, a crystalline vinyl resin, a crystalline epoxy resin, a crystalline polyether resin, and a complex resin thereof.

10. The toner mentioned above, wherein the two or more kinds of crystalline resins account for 51% by weight or more of the mass of the binder resin.

The present invention is described in detail below.

As described above, the binder resin of the toner of the present disclosure contains two or more kinds of crystalline resins.

The crystalline resin in the present disclosure has a ratio (Tm/Ta) of the softening point Tm of a resin to the endothermic peak Ta of the melting heat thereof of from 0.8 to 1.55 and distinctive endothermic peaks instead of stepwise endotherm change as measured by differential scanning calorimetry (DSC). Ta and Tm can be measured as follows:

Method of Measuring Tm

Tm is measures by using an elevated flow tester (CFT-500D, manufactured by Shimadzu Corporation). 1 g of a crystalline resin is measured as a measuring sample. Load of 1.96 MPa is applied to the sample by a plunger to extrude the sample by a nozzle having a diameter of 1 mm and a length of 1 mm while heating the sample at a temperature rising rate of 6° C./min. A graph of “plunger descending amount (flow amount)” and “temperature” is drawn to read a temperature corresponding to ½ of the maximum plunger descending amount. This value (=temperature at which a half of the sample has flown out) is defined to be Tm.

Method of Measuring Ta

The sample is measured by using a differential scanning calorimeter (DSC210, manufactured by Seico Electronics Industrial Co., Ltd.).

As preliminary treatment, the crystalline resin is melted at 130° C. followed by cooling down 130° C. to 70° C. at a temperature falling rate of 1.0° C./min. and cooling down from 70° C. to 10° C. at a temperature falling speed of 0.5° C./min. Thereafter, the sample is heated at a temperature rising rate of 20° C./min. to measure the change of endotherm and exotherm by DSC. A graph of “endotherm and exotherm amount and “temperature” is drawn. The endothermic peak temperature observed between 20° C. to 100° C. is defined as “Ta′. If there are multiple endothermic peaks, the temperature at which the amount of endotherm is the largest is determined as Ta′. Thereafter, the sample is preserved at (Ta′−10)° C. for six hours and thereafter at (Ta*−15)° C. for another six hours.

Thereafter, the sample is cooled down to 0° C. at a temperature falling rate 10° C./min. followed by heating at a temperature rising speed of 20° C./min. to measure the endotherm and exotherm change by DSC. The temperature corresponding to the maximum peak of the endotherm and exotherm amount is defined as the endothermic peak temperature Ta of the melting heat.

Specific examples of the two or more kinds of crystalline resins include, but are not limited to, a crystalline polyester resin (a1), crystalline polyurethane resin (a2), crystalline polyurea resin (a3), crystalline vinyl resin (a4), crystalline epoxy resin (a5), and a crystalline polyether (a6).

Crystalline Polyester Resin (a1)

Specific examples of the crystalline polyester resin (a1) include, polyester resins formed of diols (1) and dicarboxylic acid (2).

Specific examples of the diol (1) include, but are not limited to, alkylene glycols having 2 to 30 carbon atoms (such as ethylene glycol, 1,2-propylene glycol, 1,3-propylene glycol, 1,4-butane diol, 1,6-hexane diol, octane diol, decane diol, dodecane diol, tetradecane diol, neopentyl glycol, and 2,2-diethyl-1,3-propane diol); alkylene ether glycol having a number average molecular weight (hereinafter referred to as Mn) of from 106 to 10,000 (such as diethylene glycol, triethylene glycol, dipropylene glycol, polyehylene glycol, polypropylene glycol, and polytetramethylene ether glycol); alicyclic diols having 6 to 24 carbonatoms such as 1,4-cyclohexane dimethanol and hydrogenated bisphenol A); adducts of the above-mentioned alicyclic diols with 2 to 100 mols of allylene oxide (hereinafter referred to as AO) having an Mn of from 100 to 10,000 such as an adduct of 1,4-cyclohexane dimethanol with 10 mols of ethylene oxide (hereinafter referred to as EO); adducts of bisphenols (bisphenol A, bisphenol F, bisphenol S, etc.) having 15 to 30 carbon atoms or polyphenol (catechol, hydroquinone, resorcin, etc.) with 2 mols to 100 mols of AO (EO, propylene oxide, hereinafter referred to as PO, butylene oxide, hereinafter referred to as BO, etc.) such as adducts of bisphenol A with 2 mols to 4 mols of EO and adducts of bisphenol A with 2 mols to 4 mols of PO; polylactone diols (such as poly-ε-caprolactone diol) having a weight average molecular weight (hereinafter referred to as Mw) of from 100 to 5,000; polybutadiene diol having an Mw of from 1,000 to 20,000.

Of these, alkylene glycols and adducts of bisphnols with AO are preferable. Adducts of bisphnols with AO and mixtures of adducts of bisphnols with AO and alkylene glycols are more preferable.

Specific examples of dicarboxylic acids (2) include, but are not limited to, alkane dicarboxylic acid having 4 to 32 carbon atoms (such as succinic acid, adipic acid, sebacic acid, azelaic acid, dodecane dicarboxylic acid, and octadecane dicarboxylic acid); alkene dicarboxylic acids having 4 to 32 carbon atoms (such as maleic acid, fumaric acid, citraconic acid, and mesaconic acid); non-linear alkene dicarboxylic acid having 8 to 40 carbon atoms (such as dimeric acid, alkenyl succinic acid such as dodecenyl succinic acid, pentadecenyl succinic acid, and octadecenyl succinic acid); non-linear alkane dicarboxylic acid having 12 to 40 carbon atoms (such as alkyl succinic acid (decyl succinic acid, dodecyl succinic acid, and octadecyl succinic acid); and aromatic dicarboxylic acid having 8 to 20 carbon atoms (such as phthalic acid, isophthalic acid, terephthalic acid, and naphthalene dicarboxylic acid).

Of these, alkene dicarboxylic acids and aromatic dicarboxlic acids are preferable. Aromatic dicarboxlic acids are more preferable.

The crystalline resin (a1) preferably has a 10 or more carbon atoms in the constitution unit of the diol (1) and the dicarboxylic acid (2) in terms of the high temperature stability of toner, more preferably 12 or more, and particularly preferably from 14 or more. In terms of the low temperature fixability of toner, the number of carbon atoms is preferably 52 or less, more preferably 45 or less, particularly preferably 40 or less, and most preferably 30 or less.

Manufacturing of Crystalline Polyurethane Resin (a2)

Specific examples of the crystalline polyurethane resin (a2) include, but are not limited to, crystalline polyurethane resins (a2-1) formed of the constitution unit of the diol (1) and/or dimaine (3) and diisocyanate (4); and crystalline polyurethane resins (a2-2) formed of the constitution unit of the crystalline polyester resin (a1), the diol (1) and/or dimaine (3), and diisocyanate (4).

Specific examples of the diamine (3) include, but are not limited to, aliphatic diamines having 2 to 18 carbon atoms and aromatic diamines having 6 to 20 carbon atoms. Specific examples of the aliphatic diamines having 2 to 18 carbon atoms include, but are not limited to, chain aliphatic diamines and cyclic aliphatic diamines.

Specific examples of the chain aliphatic diamines include, but are not limited to, alkylene diamines having 2 to 12 carbon atoms (such as ethylene diamine, propylene diamine, trimethylene diamine, tetramethylene diamine, and hexamethylene diamine); and polyalkylene (2 to 6 carbon atoms) polyamine (such as diethylene triamine, iminobis peopyle amine, bis(hexamethylene)triamine, triethylene tetramine, tetraethylene pentamine, and pentaethylene hexamine.

Specific examples of the cyclic aliphatic diamines include, but are not limited to, alicyclic dimaines having 4 to 15 carbon atoms {such as 1,3-diaminocyclihexane, isophorone diamine, menthene-diamine, 4,4′-methylene dicyclohexane diamine (such as hydrogenated methylene dianiline), and 3,9-bis(3-aminpropyl-2,4,8,10-tetra oxaspiro[5,5]undecane}; and heterocyclic diamines having 4 to 15 carbon atoms (such as piperazine, N,N-aminoethyl piperazine, 1,4-diaminoethyl piperazine, and 1,4-bis(2-amino-2-methyl propyl)piperazine.

Specific examples of the aromatic diamines having 6 to 20 carbon atoms include, but are not limited to, non-substituted aromatic diamines and aromatic diamines having an alkyle group having 1 to 4 carbon atoms such as methyl group, ethyl group, n- or i-propyle group, and butyl group).

Specific examples of the non-substituted aromatic diamines include, but are not limited to, 1,2-, 1,3- or 1,4-phenylene diamine, 2,4′- or 4,4′-diphenyl methane diamine, diamino diphenyl sulfone, bendidine, thiodianiline. bis(3,4-diaminophenyl)sulfone, 2,6-diamino pilidine, m-aminobenzyl amine, naphthylene diamine, and mixtures thereof.

Specific examples of the aromatic diamines having an alkyle group having 1 to 4 carbon atoms such as methyl group, ethyl group, n- or i-propyle group, and butyl group include, but are not limited to, 2,4-, or 2,6-tolylene diamine, crude tolylene diamine, diethyl tolylene dimaine, 4,4′-dimaino-3,3′-dimethyldiphenyl methane, 4,4′-bis(o-toluidine), dianisidine, diaminoditolyl sulfone, 1,3-dimethyl-2,4-diaminobenzene, 1,3-diethyl-2,4-diaminobenzene, 1,3-dimethyl-2,6-diaminobenzene, 1,4-diethyl-2,5-diaminobenzene, 1,4-diisopropyl-2,5-diaminobenzene, 1,4-dibutyl-2,5-diaminobenzene, 2,4-diaminomesitylene, 1,3,5-triethyl-2,4-diamino benzene, 1,3,5-triisopropyl-2,4-diamino benzene, 1-methyl-3,5-diethyl-2,4-diamino benzene, 1-methyl-3,5-diethyl-2,6-diamino benzene, 2,3-dimethyl-1,4-diaminonaphthalene, 2,6-dimethyl-1,5-diaminonaphthalene, 2,6-diisopropyl-1,5-diaminonaphthalene, 2,6-dibutyl-1,5-diaminonaphthalene, 3,3′,5,5′-tetramethyl benzidine, 3,3′,5,5′-tetraisopropyl benzidine, 3,3′,5,5′-tetramethyl-4,4′-diaminodiphenyl methane, 3,3′,5,5′-tetraethyl-4,4′-diaminodiphenyl methane, 3,3′,5,5′-tetraisopropyl-4,4′-diaminodiphenyl methane, 3,3′,5,5′-tetrbutyl-4,4′-diaminodiphenyl methane, 3,5-diethyl-3′-methyl-2′,4-diaminodiphenyl methane, 3,5-diisopropyl-3′-methyl-2′,4-diaminodiphenyl methane, 3,3′-diethyl-2,2′-diaminodiphenyl methane, 4,4′-diamino-3,3′-dimethyldiphenyl methane, 3,3′,5,5′-tetraethyl-4,4′-diaminobenzophenone, 3,3′,5,5′-tetraisopropyl-4,4′-diaminobenzophenone, 3,3′,5,5′-tetraethyl-4,4′-diaminodiphenyl ether, and 3,3′,5,5′-tetraisopropyl-4,4′-diaminodiphenyl sulfone.

Specific examples of the diisocyanate (4) include, but are not limited to, aromatic diisocyanates having 6 to 20 carbon atoms, aliphatic diisocyanates having 2 to 18 carbon atoms, modified compounds thereof (modified by a urethane group, a carbodiimide group, an allophanate group, a urea group, a biuret group, a uretodione group, a uretoiine group, an isocyanate group, or an oxazolidone group) and mixtures thereof.

Specific examples of the aromatic diisocyanates include, but are not limited to, 1,3- or 1,4-phenylene diisocyanate, 2,4- or 2,6-tolylene diisocyanate (TDI), crude TDI, m-, or p-xylylene diisocyanate (XDI), α,α,α′,α′-tetramethyl xylylene diisocyanate (TMXDI), 2,4′- or 4,4′-diphenyl methane diisocyaante (MDI), crude MDI {crude diaminophenyl methane [condensed product of formaldehyde and an aromatic amine (aniline) or a mixture thereof}, and mixtures thereof.

Specific examples of the aliphatic diisocyanate include, but are not limited to, chain aliphatic diisocyanates and cyclic aliphatic diisocyanates.

Specific examples of the chain aliphatic isocyanates include, but are not limited to, etyhlene diisocyanate, tetramethylene diisocyanate, hexamethylene diisocyanate (HDI), dodecamethylene diisocyanate, 2,2,4-trimethyl hexamethylene diisocyanate, lysine diisocyanate, 2,6-diisocyanato methyl caproate, bis(2-isocyanato ethyl)fumarate, bis(2-isocyanato ethyl) carbonate, 2-isocyanatoethyl-2,6-diisocyanato hexanoate, and mixtured thereof.

Specific examples of the alicyclic isocyanates include, but are not limited to, isophorone diisocyanate (IPDI), dicyclo hexyl methane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, 2,5- or 2,6-norbornane diisocyanate, and mixtures thereof.

Specific examples of the modified compounds of diisocyanates include, but are not limited to, diisocyanates modified by a urethane group, a carbodiimide group, an allophanate group, a urea group, a biuret group, a uretodione group, a uretoiine group, an isocyanate group, or an oxazolidone group, modified MDI (urethane-modified MDI, carbodiimide modified MDI, trihydrocarbonyl phosphate-modified MDI, etc.), urethane-modified TDI, and mixtures thereof (for example, a mixture of modified MDI and urethane-modified TDI (prepolymer containing an isocyanate).

Of these, aromatic diisocyanates having 6 to 15 carbon atoms and aliphatic diisocyanates having 4 to 15 carbon atoms are preferable. TDI, MDI, HDI, hydrogenated MDI, and IPDI are more preferable.

In addition to the diol (1) mentioned above, the crystalline polyeurethane resin (a2) can have a diol (1′) having at least one of a carboxylic acid (salt) group, sulphonic acid (salt) group, sulfamic acid (salt) group, and phosphoric acid (salt) group as a constitution unit. Toner having the crystalline polyeurethane resin (a2) has stable chargeability and high temperature stability.

Acid (salt) represents acid and a salt thereof in the present disclosure.

Specific examples of the diol (1′) having a carboxylic acid (salt) include, but are not limited to, tartaric acid (salt), 2,2-bis(hydroxylmethyl)propane acid (salt), 2,2-bis(hydroxylmethyl)butane acid (salt), and 3-[bis(2-hydroxylethyl)amino]propane acid (salt).

Specific examples of the diol (1′) having a sulphonic acid (salt) include, but are not limited to, 2,2-bis(hydroxylmethyl)ethane sulphonic acid (salt), 2-[bis(2-hydroxylethyl)amino]ethane sulphonic acid (salt), and 5-sulfo-isophtalic acid-1,3-bis(2-hydroxylethyl)ester (salt).

Specific examples of the diol (1′) having a sulfamic acid (salt) include, but are not limited to, N,N-bis(2-hydroxyethyl)sulfamic acid (salt), N,N-bis(3-hydroxypropyl)sulfamic acid (salt), N,N-bis(4-hydroxybutyl)sulfamic acid (salt), and N,N-bis(2-hydroxypropyl)sulfamic acid (salt).

A specific example of the diol (1′) having a phosphoric acid (salt) is bis(2-hydroxyethyl)phosphate (salt).

Specific examples of the salts forming acid salts include, but are not limited to, ammonium salts, amine salts (methyl amine salts, dimethyl amine salts, trimethyl amine salts, ethyl amine salts, diethyl amine salts, triethyl amine salts, propyl amine salts, dipropyl amine salts, tripropyl amine salts, butyl amine salts, dibutyl amine salts, tributyl amine salts, monoethanol amine salts, diethenol amine salts, triethanol amine salts, N-methyl ethanol amine salts, N-ethyl ethanol amine salts, N,N-dimethyl ethanol amine salts, N,N-diethyl ethanol amine salts, hydroxylamine salts, N,N-diethyl hydroxylamine salts, and morphorine salts), quaternary ammonium salts (such as tetramethyl ammonium salts, tetraethyl ammonium salts, and trimethyl(2-hydroxyethyhl)ammonium salts), and alkali metals salts (such as sodium salts and potassium salts).

Of these diols (1′), diol (1′) having a carboxylic acid (salt) group and diol (1′) having a sulphonic acid (salt) group are preferable in terms of the chargeability and high temperature stability of toner.

Crystalline Polyurea Resin (a3)

A specific example of the crystalline polyurea resin (a3) is a resin having the diamine (3) and the diisocyanate (4) as the constitution units.

Crystalline Vinyl Resin (a4)

The crystalline vinyl resin (a4) is a polymers formed by monopolymerizing or copolymerizing monomers having polymerizable double bonds. Specific examples of the monomers having polymerizable double bonds include, but are not limited to, the following (5) to (13).

(5) Hydrocarbon Having Polymerizable Double Bond

(5-1) Aliphatic Hydrocarbon Having Polymerizable Double Bond

(5-1-1) Chain Hydrocarbon Having Polymerizable Double Bond

Alkenes having 2 to 30 carbon atoms (such as ethylene, propylene, butane, isobutylene, pentene, heptene, diisobutylene, octane, dodecene, and octadecene); and alkadiens (such as butadiene, isoplene, 1,4-pentadiene, 1,6-hexadiene, and 1,7-octadiene).

(5-1-2) Cyclic Hydrocarbon Having Polymerizable Double Bond

Mono or dicycloalkenes having 6 to 30 carbon atoms (such as cyclohexene, vinyl cyclohexene, and ethylidene bicycloheptene); and mono or dicycloalkadienes having 5 to 30 carbon atoms [such as (di)cyclopentadiene].

(5-2) Aromatic Hydrocarbon Having Polymerizable Double Bond Styrene;

hydrocarbyl (alkyl, cycloalkyl, aralkyl, and/or alkenyl having 1 to 30 carbon atoms) substitutes of styrene such as α-methylstyrene, vinyl toluene, 2,4-dimethylstyrene, ethylstyrene, isopropyl styrene, butylstyrene, phenylstyrene, cyclohexylstyrene, benzylstyrene, crotylbenzene, divinylbenzene, divinyltoluene, divinyl xylene, and trivinyl benzene); and vinyl naphthalene.

(6) Monomer Having Caroboxylic Group and Polymerizable Double Bond and Salt Thereof

Unsaturated monocarboxylic acid having 3 to 15 carbon atoms {such as (meth)acrylic acid [(meth)acrylic represents acrylic or methacrylic], crotonic acid, isocrotonic acid, and cinnamic acid}; unsaturated dicarboxylic acid (anhidride) having 3 to 30 carbon atoms [such as maleic acid and anhydride thereof, fumaric acid, itaconic acid, citraconic acid and anhydride thereof, and mesaconic acid]; Monoalkyl (having 1 to 10 carbon atoms) esters of unsaturated dicarboxylic acid having 3 to 10 carbon atoms (such as monomethylester of maleic acid, monodecyl ester of maleic acid, monoethyl ester of fumaric acid, and monobutyl ester of itaconic acid, monodecyl ester of citraconic acid).

Specific examples of the salts constituting salts of monomers having a carboxylic acid group and a polymerizable double bond include, but are not limited to, alkali metal salts (sodium salts, potassium salts, etc.), alkali earth metal salts (calcium salts, magnesium salts, etc.), ammonium salts, amine salts, quaternary ammonium salts, etc.

Specific examples of the amine salts include, but are not limited to, primary amine salts (such as ethyl amine salts, butyl amine salts, and octyl amine salts); secondary amine salts such as (diethyl amine salts and dibutyl amine salts); and tertiary amine salts (such as triethyl amines and tributyl amine salts).

Specific examples of the quaternary ammonium salts include, but are not limited to, tetraethyl ammonium salts, triethyl lauryl ammonium salts, tetrabutyl ammonium salts, and tributyl lauryl ammonium salts.

Specific examples of the salts of the monomer having a carboxylic acid group and a polymerizable double bond include, but are not limited to, sodium acrylate, sodium methacrylate. monosodium maleate, disodium maleate, potassium acrylate, potassium methacrylate, monopotassium maleate, lithium acrylate, cesium acrylate, ammonium acrylate, calcium acrylate, and aluminum acrylate.

(7) Monomer Having Sulphonic Group and Polymerizable Double Bond and Salt Thereof

Alkene sulphonic acid having 2 to 14 carbon atoms such as vinyl sulphonic acid, (meth)allyl sulphonic acid, methylvinyl sulphonic acid; styrene sulphonic acid and their alkyl delivatives having 2 to 24 carbon atoms such as α-methylstyrene sulphonic acid; sulpho(hydroxy)alkyl-(meth)acrylate having 5 to 18 carbon atoms (such as sulphopropyl(meth)acrylate, 2-hydroxy-3-(meth)acryloxy propylsulphonic acid, 2-(meth)acryloyloxy ethane sulphonic acid, and 3-(meth)acryloyloxy-2-hydroxy propane sulphonic acid); suoph(hydroxy)alkyl)(meth)acryl amide having 5 to 18 carbon atoms (such as 2-(meth)acryloyl amino-2,2-dimethyl ethane sulphonic acid, 2-(meth)acrylamide-2-methyl propane sulphonic acid, and 3-(meth)acrylamide-2-hydroxy propane sulphonic acid); alkyl (having 3 to 18 carbon atoms) allyl sulphosuccinic acid (such as propyl allyl sulphsuccinic acid, butyl allyl sulphosuccinic acid, 2-ethylhexyl-allylsulphosuccinic acid); Esters of poly(polymerization degree n=2 to 30)oxyalkylene (such as oxyethylene, oxypropylene, and oxybutylenes. Oxyalkylenes can be used alone or in combination. When used in combination, both random addition and block addition are possible) mono(meth)acrylate, for example, esters of sulfuric acid of poly(n=5 to 15) oxyethylene monomethacrylate; compounds represented by the following chemical formula (1) to chemical formula (3); and salts thereof.

Specific examples of the salts include, but are not limited to, (6) the salts constituting salts of monomers having a carboxylic acid group and a polymerizable double bond.

[chemical structure]

In these chemical formulae, R¹ represents an alkylene group having 2 to 4 carbon atoms. m and n each, independently represent integers of from 1 to 50. When n or m is not 1, any of R¹O is independent from each other and their bond is random or block. R² and R³ independently represent alkyl groups having 1 to 15 carbon atoms. Ar represents a benzene ring. R⁴ represents an alkyl group having 1 to 15 carbon atoms which can be substituted by a fluorine atom.

(8) Monomer Having Phosphono Group and Polymerizable Double Bond and Salt Thereof

Phosphoric acid monoester of (meth)acryloyl oxyalkyl (alkyl having 1 to 24 carbon atoms) such as 2-hydroxyethyl(meth)acryloyl phosphate and phenyl-2-acyloyloxyethylphosphate); (meth)acryloyloxyalkyl (alkyl having 1 to 24 carbon atoms) phosphonic acids such as 2-acryloyloxy ethylphosphonic acid, and their salts. Specific examples of the salts include, but are not limited to, (6) the salts constituting salts of monomers having a carboxylic acid group and a polymerizable double bond.

(9) Monomer Having Hydroxyl Group and Polymerizable Double Bond

Hydroxystyrene, N-methylol(meth)acryl amide, hydroxyethyl(meth)acrylate, hydroxypropyl(meth)acrylate, polyethylene glycol mono(meth)acrylate, (meth)allyl alcohol, crotyl alcohol, isocrotyl alcohol, 1-butene-3-ol, 2-butene-1-ol, 2-butene-1,4-diol, propargyl alcohol, 2-hydroxyethylpropenyl ether, simple sugar allyl ether, etc.

(10) Nitrogen-containing Monomer Having Polymerizable Double Bond

(10-1) Monomer Having Amino Group and Polymerizable Double Bond aminoethyl(meth)acrylate, dimethylaminoethyl(meth)acrylate, diethylaminoethyl(meth)acrylate, t-butylaminoethyl(meth)acrylate, N-aminoethyl(meth)acrylamide, (metha)allylamine, morpholino ethyl(meth)acrylate, 4-vinylpyridine, 2-vinylpyridine, crotyl amine, N,N-dimethylaminostyrene, methyl-α-acetoaminoacrylate, vinylimidazole, N-vinylpyrrole, N-vinylthiopyrolidone, N-allylphenylene diamine, aminocarbozole, aminothiazole, aminoindole, aminopyrrole, aminoimidazole, aminomercaptothiazole, and their salts.

(10-2) Monomer Having Amide Group and Polymerizable Double Bond (meth)acrylamide, N-methyl(meth)acrylamide, N-butylacrylamide, diacetone acrylamide, N-methylol(meth)acrylamide, N,N-methylene-bis(meth)acrylamide, cinnamic amide, N,N-dimethylacrylamide, N,N-dibenzylacrylamide, methacrylformamide, N-methyl-N-vinylacetoamide, and N-vinylpyrolidone.

(10-3) Monomer Having Nitrile Group and Polymerizable Double Bond (meth)acrylonitrile, cyano styrene, and cyanoacrylate.

(10-4) Monomer Having Nitro Group and Polymerizable Double Bond and 8 to 12 Carbon Atoms

Nitrostyrene, etc.

(11) Monomer Having Epoxy Group and Polymerizable Double Bond and 6 to 18 Carbon Atoms

glycidyl(meth)acrylate and p-vinyl phenyl phenyl oxide.

(12) Monomer Having Halogen Element and Polymerizable Double Bond and 2 to 16 Carbon Atoms

vinyl chloride, vinyl bromide, vinylidene chloride, allyl chloride, chlorostyrene, brom styrene, dichlorostyrene, chlolomethyl styrene, tetrafluorostyrene, and chloroprene.

(13) Ester Having Polymerizable Double Bond, Ether Having Polymerizable Double Bond, Ketone Having Polymerizable Double Bond, and Sulfur Containing Compound Having Polymerizable Double Bond

(13-1) Ester Having Polymerizable Double Bond and 4 to 16 Carbon Atoms Vinyl acetate, vinyl propionate, vinyl butyrate, diallylphthalate, diallyladipate, isopropenyl acetate, vinylmethacrylate, methyl-4-vinylbenzoate, cyclohexylmethacrylate, benzylmethacrylate, phenyl(meth)acrylate, vinylmethoxyacetate, vinylbenzoate, ethyl-α-ethoxyacrylate, alkyl (having 1 to 50 carbon atoms) (meth)acrylate such as methyl(meth)acrylate, ethyl(meth)acrylate, propyl(meth)acrylate, butyl(meth)acrylate, 2-ethylhexyl(meth)acrylate, dodecyl(meth)acrylate, hexadecyl(meth)acrylate, heptadecyl(meth)acrylate, and eicocyl(meth)acrylate), dialkyl malate (in which two alkyl groups are straight chained, branch chained, or cyclic chained groups and have 2 to 8 carbon atoms), poly(meth)allyloxyalkanes such as diallyloxyethane, triallyloxyethane, tetraallyloxyethane, tetraallyloxypropane, tetraallyloxybutane and tetramethallyloxyethane, monomers having polyalkylene glycol chain and polymerizable double bond such as polyethylene glycol (molecular weight: 300) mono(meth)acrylate, polypropylene glycol (molecular weight: 500) monoacrylate, methacrylates of adducts of (methyl alcohol with 10 mol of EO, and (meth)acrylate of adducts of lauryl alcohol with 30 mols of EO), poly(meth)acrylates such as poly(meth)acrylates of polyols (e.g., ethylene glycol di(meth)acrylate, propylene glycol di(meth)acrylate, neopentylglycol di(meth)acrylate, trimethylol propane tri(meth)acrylate, and polyethylene glycol di(meth)acrylate).

(13-2) Ether Having Polymerizable Double Bond and 3 to 16 Carbon Atoms vinylmethyl ether, vinylethyl ether, vinylpropyl ether, vinylbutyl ether, vinyl-2-ethylhexyl ether, vinylphenyl ether, vinyl-2-methoxyethyl ether, methoxy butadiene, vinyl-2-buthxyethyl ether, 3,4-dihydro-1,2-pyrane, 2-buthoxy-2′-vinyloxy diethyl ether, acetoxystyrene, and phenoxy styrene.

(13-3) Ketone Having Polymerizable Double Bond and 4 to 12 Carbon Atoms vinyl methyl ketone, vinyl ethyl ketone, and vinyl phenyl ketone.

(13-4) Sulfur Containing Compound Having Polymerizable Double Bond and 2 to 16 Carbon Atoms

divinylsulfide, p-vinyldiphenyl sulfide, vinylethyl sulfide, vinylethyl sulphone, divinyl sulphone, and divinyl sulphoxide.

Crystalline Epoxy Resin (a5)

Specific examples of the crystalline epoxy resins (a5) include, but are not limited to, ring-opened compound of polyepoxide (14) and polyadded compound of polyepoxide (14) and active hydrogen containing compound [such as water, diol (1), dicarboxylic acid (2), and diamine (3)].

Polyepoxide (14) has two or more epoxy groups in its molecule. The polyepoxide (14) having 2 to 6 epoxy groups in its molecule is preferable in terms of mechanical characteristics of cured material. The epoxy equivalent (molecular weight per epoxy group) of the polyepoxide (14) is preferably from 65 to 1,000 and more preferably from 90 to 500. When the epoxy equivalent is 1,000 or less, the cross-linked structure of the polyepoxide (14) is dense, thereby improving water-proof of a cured material, chemical resistance, and mechanical strength. However, it is difficult to synthesize the polyepoxide (14) having an epoxy equivalent of 65 or less.

Specific examples of the polyepoxide (14) include, but are not limited to, aromatic polyepoxy compounds, heterocyclic polyepoxy compounds, alicyclic polyepoxy compounds, and aliphatic polyepoxy compounds.

Specific examples of the aromatic polyepoxy compounds include, but are not limited to, glycidyl ether body and glycidyl ester body of polyphenols, glycidyl aromatic polyamines, and glycidylated amonophenols.

Specific examples of the glycidyl ether body of polyphenols include, but are not limited to, bisphenol F diglycidyl ether, bisphenol A diglycidyl ether, bisphenol B diglycidyl ether, bisphenol AD diglycidyl ether, bisphenol S diglycidyl ether, halogenized bisphenol A diglycidyl ether, tetrachloro bisphenol A diglycidyl ether, catechin diglycidyl ether, resorcinol diglycidyl ether, hydroquinone diglycidyl ether, pyrogallol triglycidyl ether, 1,5-dihydroxy naphthalene diglycidyl ether, dihydroxy biphenyl diglycidyl ether, octachloro-4,4′-dihydroxy biphenyl diglycidyl ether, tetramethyl biphenyl diglycidyl ether, dihydroxy naphtyl cresol triglycidyl ether, dihydroxy naphtyl cresol triglycidyl ether, tris(hydroxyphenyl)methane triglycidyl ether, dinaphtyl triol triglycidyl ether, tetrakis(4-hydroxyphenyl)ethane tetraglycidyl ether, p-glycidyl phenyl dimethyl tolyl bisphenol A glycidyl ether, triemethyl-t-butyl-butylhydroxy methane triglycidyl ether, 9,9′-bis(4-hydroxyphenyl)fluorene glycidyl ether, 4,4′-oxybis′1,4-phenylethyl)tetracresol glycidyl ether, 4,4′-oxybis(1,4-phenylethyl)phenyl glycidyl ether, bis(dihydroxynaphthalene)tetraglycidyl ether, glycidyl ether body of phenol or cresol novolac resin, glycidyl ether body of limonene phenol novolac resin, glycidyl ether body obtained by reaction between 2 mols of bisphenol A and 3 mols of epichlorohydrine, poly glycidyl ether body of polyphenol obtained by condensation reaction between phenol, glyoxazole, glutaraldehyde or formaldehyde, and poly glycidyl ether body of polyphenol obtained by condensation reaction between resorcin and acetone.

Specific examples of glycidyl ether body of polyphenol include, but are not limited to, phthalic acid diglycidyl ester, isophthalic acid diglycidyl ester, and terephthalic acid diglycidyl ester.

Specific examples of the glycidyl aromatic polyamines include, but are not limited to, N,N-diglycidyl aniline, N,N,N′N′-tetra glycidyl xylylene diamine, and N,N,N′N′-tetra glycidyl diphenyl methane diamine. Furthermore, specific examples of the aromatic compounds include, but are not limited to, diglycidyl urethane compounds obtained by addition reaction of triglycidyl ether of p-amionophenol, diglycidyl urethane compounds obtained by addition reaction of tolylene diisocyanate or diphenyl methane diisocyanate, and glycidyl, glycidyl group containing polyurethane (pre)polymer obtained by reacting the two reactants, and a diglycidyl ether body of an adduct of bisphenol A with AO.

A specific example of the heterocyclic polyepoxy compounds is trisglycidyl melamine.

Specific examples of the alicyclic polyepoxy compounds include, but are not limited to, vinylcyclohexene dioxide, limonene dioxide, dicyclopentane dioxide, bis(2,3-eoixycyclo pentyl)ether, ethylene glycol bisepoxy dicyclohexyl penthyl ether, 3,4-epoxy-6-methylcyclohexyl methyl-3′-4′-epoxy-6′-methylcyclohexane carboxylate, bis(3,4-epoxy-6-methylcyclohexylmethyl)adipate, bis(3,4-epoxy-6-methylcyclohexylmethyl)butyl amine, and diglycidyl esters of dimeric acid. Nuclear hydrogenated compound of the aromatic polyepoxide compound is included as the alicyclic compound.

Specific examples of the aliphatic polyepoxy compounds include, but are not limited to, polyglycidyl ether bodies of polyaliphatic alcohols, polyglycidyl ester bodies of polyalicphatic acids, and glycidyl aliphatic amines.

Specific examples of the polyglycidyl ether bodies of polyaliphatic alcohols include, but are not limited to, ethylene glycol diglycidyl ether, propylene glycol diglycidyl ether, tetramethylene glycol diglycidyl ether, 1,6-hexane diol diglycidyl ether, polyethylene glycol diglycidyl ether, polypropylen glycol diglycidyl ether, polytetra methylene glycol diglycidyl ether, neopentyl glycol diglycidyl ether, trimethylol propane polyglycidyl ether, glycerol polyglycidyl ether, pentaerythritol polyglycidyl ether, sorbitol polyglycidyl ether, and polyglycerol polyglycidyl ether.

Specific examples of the polyglycidyl ester bodies of polyaliphatic acids include, but are not limited to, diglycidyl oxalate, diglycidyl maleate, diglycidyl succinate, diglycidyl glutarate, diglycidyl adipate, and diglycidy lpimelate.

A specific example of the glycidyl aliphatic amine is N,N,N′N′-tetraglycidyl hexamethylene diamine. Copolymers of diglycidyl ether and glycidyl (meth)acrylate are also included as the aliphatic compounds.

Aliphatic polyepoxy compounds and aromatic polyepoxy compounds are preferable as the polyepoxyde (14). Polyepoxides can be used alone or in combination.

Crystalline Polyether Resin (a6)

Specific examples of the crystalline polyether resin (a6) include, but are not limited to, crystallinepolyoxyalkylene polyols.

There is no specific limit to the method of manufacturing crystalline polyoxy alkylene polyol. Any known method is suitable.

For example, there are a method of ring-opening polymerization of a chiral body of polyoxyalkylene polyol by a catalyst for use in typical polymerization thereof (Journal of the American Chemical Society, p. 4787 to p. 4792, Issue No. 18, Vol. 79, published in 1956) and a method of ring-opening polymerizion of an inexpensive racemic body of polyoxyalkylene polyol by using a complex having a sterically-bulky special chemical structure as catalyst.

To be specific, JP-H11-12353-A describes a method of using a compound obtained by contacting a lantanoid complex and an organic aluminum as catalyst and JP-2001-521957-A describes a method of preliminarily conducting reaction between bimetal μ-oxo alkoxide and a hydroxyl compound.

Also, Journal of the American Chemical Society published in 2005 describes a suitable method using a salen complex as catalyst to obtain a crystalline polyoxyalkylene polyol having a high isotacticity on pages 11,566 to 11,567 in No. 33, Vol. 127.

For example, by using a glycol or water as an initiator during ring-opening polymerization using a chiral body of polyoxyalkylene polyol, a polyoxyalkylene glycol having a hydroxyl group at its end with 50% or more isotacticity is obtained. Polyoxyalkylene glycol with 50% or more isotacticity modified to have a carboxyl group at its end is also suitable. Polyoxyalkylene glycol normally has crystallinity when it has an isotacticity of 50% or more.

As the glycol, the diol (1) can be used. As the carboxylic acid to conduct carboxy modification, the dicarboxylic acid (2) can be used.

Specific examples of the materials for use in manufacturing of crystalline polyoxyalkylene polyol include, but are not limited to, propylene oxide, 1-chlorooxetane, 2-chlorooxetane, 1,2-dichlorooxetane, epichlorohydrin, epibromohydrin, butylene oxide, methyl glycidyl ether, 1,2-penthylene oxide, 2,3-penthylene oxide, 3-methyl-1,2-buthylene oxide, cyclohexene oxide, 1,2-hexylene oxide, 3-methyl-1,2-pentylene oxide, 2,3-hexylene oxide, 4-methyl-2,3-penthylene oxide, allyl glycidyl ether, 1,2-heptylene oxide, styrene oxide, and phenyl glycidyl ether.

These materials can be used alone or in combination.

Of these, propylene oxide, butylene oxide, styrene oxide, and cyclohexene oxide are preferable.

Of the two or more kinds of crystalline resins, in terms of the strength of attachment of toner, the crystalline polyester resin (a1) and the crystalline polyurea resin (a2) are preferable, the crystalline polyurea resin (a2) are more preferable, the crystalline polyurea resin (a2-2) are particularly preferable, and the crystalline polyurea resin (a2-2) having an ester group and a urethane group in its molecule is most preferable.

The two or more kinds of the crystalline resins have two or more endothermic peaks as measured by differential scanning calorimetry (DSC). In other words, the crystalline resins have multiple endothermic peaks (not only a single peak) in any combinations of the two or more kinds of the crystalline resins.

To be specific, as shown in the set 1 below, the crystalline resins of the present disclosure have a combination of five kinds of crystalline resins (a-1) to (a-5) with two different endothermic temperatures Tas, i.e., two different endothermic peaks. In addition, in the case of the set 2 shown below, the crystalline resins of the present disclosure have a combination of five kinds of crystalline resins (a-6) to (a-10) with five different endothermic temperatures Tas, i.e., five different endothermic peaks.

Set 1 of Two or More Kinds of Crystalline Resins

Crystalline resin (a-1): Ta=50° C.
Crystalline resin (a-2): Ta=50° C.
Crystalline resin (a-3): Ta=50° C.
Crystalline resin (a-4): Ta=50° C.
Crystalline resin (a-5): Ta=52° C.

Set 2 of Two or More Kinds of Crystalline Resins

Crystalline resin (a-6): Ta=53° C.
Crystalline resin (a-7): Ta=60° C.
Crystalline resin (a-8): Ta=58° C.
Crystalline resin (a-9): Ta=71° C.
Crystalline resin (a-10): Ta=84° C.

However, as shown in the set 3 below, a combination of five kinds of crystalline resins (a-11) to (a-15) with a single endothermic temperature Ta, i.e., one endothermic peak means that the two or more kinds of the crystalline resins do not have two or more endothermic peaks as measured by differential scanning calorimetry (DSC).

Set 3 of Two or More Kinds of Crystalline Resins

Crystalline resin (a-11): Ta=62° C.
Crystalline resin (a-12): Ta=62° C.
Crystalline resin (a-13): Ta=62° C.
Crystalline resin (a-14): Ta=62° C.
Crystalline resin (a-15): Ta=62° C.

Each of endothermic peaks of the two or more kinds of crystalline resins is preferably from 40° C. to 120° C., more preferably from 45° C. to 100° C., and particularly preferably from 50° C. to 90° C. in terms of the balance between low temperature fixability and high temperature stability.

Among the endothermic peaks of the two or more kinds of crystalline resins, the difference between the highest endothermic temperature (hereinafter referred to as TaMAX) and the lowest endothermic temperature (hereinafter referred to as TaMIN) is preferably from 3° C. to 40° C., more preferably from 5° C. to 35° C., and particularly preferably from 7° C. to 30° C. in terms of the balance between low temperature fixability and hot offset resistance.

The two or more kinds of crystalline resins satisfy the following relation in measuring of viscoelasticity of a mixture of the two or more kinds of crystalline resins:

0° C.<Tup−Tdown≦30° C.,

where Tup represents a temperature at which the two or more kinds of crystalline resins have a storage elastic modulus of 1.0×10⁶ Pa at a temperature rising rate of 10° C./minute from 30° C. and Tdown represents a temperature at which the two or more kinds of crystalline resins have a storage elastic modulus of 1.0×10⁶ Pa at a temperature falling rate of 10° C./minute from a temperature of Tup+20° C.

The hot offset of toner is improved by satisfying the relation.

In the present disclosure, the viscoelasticity of the two or more kinds of crystalline resins is measured by using a dynamic viscoelasticity measuring device (RDS-2, manufactured by Rheometric Scientific, Inc) under the condition of a frequency of 1 Hz.

To be specific, the viscoelasticity of a mixture of the two or more kinds of crystalline resins is set in the jig of the measuring device (the mixing ratio is according to the actual ratio in toner); the crystalline resins are heated to (Ta+30)° C. to be attached to the jig; thereafter, the crystalline resin is cooled down from (Ta+30° C.) to (Ta−30° C.) at a temperature falling rate of 0.5° C./minute followed by one-hour aging; the crystalline resin is heated to (Ta−10)° C. at a temperature falling rate of 0.5° C./minute to sufficiently proceed crystallization for measuring Tup and Tdown.

In the present disclosure, a resin formed of only a crystalline unit (x) selected from the crystalline polyester resin (a1), the crystalline polyurethane resin (a2), the crystalline polyurea resin (a3), the crystalline vinyl resin (a4), the crystalline epoxy resin (a5), the crystalline polyether resin (a6), and a complex resins thereof can be used as the two or more kinds of crystalline resins. A block resin formed of one or more crystalline portions and a non-crystalline portion (y) formed of a non-crystalline resin (b) can be also used as the two or more kinds of crystalline resins.

The non-crystalline resin (b) has a similar composition to the crystalline polyester resin (a1), the crystalline polyurethane resin (a2), the crystalline polyurea resin (a3), the crystalline vinyl resin (a4), the crystalline epoxy resin (a5), the crystalline polyether resin (a6), and a complex resins thereof as specified as examples of the two or more kinds of crystalline resins. The non-crystalline resin (b) has a ratio (Tm/Ta) greater than 1.55.

If a block resin formed of a crystalline portion (x) and a non-crystalline portion (y) is contained in the two or more kinds of crystalline resins, whether to use a binding agent is determined considering the reaction properties of the functional groups located at the ends of the crystalline portion (x) and the non-crystalline portion (y). Once usage of a binding agent is determined, a suitable binding agent is selected to the functional groups at their ends to bond the crystalline portion (x) and the non-crystalline portion (y), thereby forming a block resin.

If no usage of a binding agent is determined, reaction is conducted between the functional group situated at the end of the crystalline portion (x) and the functional group situated at the end of the non-crystalline portion (y) while being heated with a reduced pressure, if desired. In a case of reaction between an acid and an alcohol or an acid or and an amine, the reaction proceeds smoothly in a combination of one of the resins having a high acid value and the other having a high hydroxy value and an amine value. The reaction temperature is preferably between 180° C. and 230° C.

A variety of binding agents can be optionally used. Specific examples of the binding agents include, but are not limited to, the diol (1), the dicarboxylic acid (2), the diamine (3), the diisocyanate (4), and the epoxy (14).

The crystalline portion (x) and the non-crystalline portion (y) are bonded by dehydration reaction, addition reaction, etc.

When both of the crystalline portion (x) and the non-crystalline portion (y) have hydroxy groups, dehydration reaction is conducted using a binding agent that bonds these portions such as the dicarboxylic acid (2). Dehydration reaction can be conducted between 180° C. and 230° C. under no presence of a solvent.

As addition reaction, when both of the crystalline portion (x) and the non-crystalline portion (y) have hydroxy groups, addition reaction is conducted using a binding agent that bonds these portions such as the diisocyanate (4). When one of the crystalline portion (x) and the non-crystalline portion (y) is a resin having a hydroxy group and the other, a resin having an isocyanate group, addition reaction can be conducted without using a binding agent.

Addition reaction can be conducted by dissolving both of the crystalline portion (x) and the non-crystalline portion (y) in a solvent that dissolves these followed by reaction between 80° C. and 150° C. with an optional binding agent.

The content ratio of the crystalline portion (x) in a block copolymer (crystalline resin) formed of a crystalline portion (x) and a non-crystalline portion (y) is preferably from 50% by weight to 99% by weight, more preferably from 55% by weight to 98% by weight, particularly preferably from 60% by weight to 95% by weight, and most preferably from 62% by weight to 80% by weight. When the content ratio of the crystalline portion (x) is within this range, the crystallinity of the crystalline resin is not impaired and the low temperature fixability, stability, and gloss of toner are improved.

At least one of the two or more kinds of crystalline resins is preferably a resin containing the crystalline portion (x) and a urethane bond in terms of low temperature fixability and hot offset resistance.

As the resin having a crystalline portion (x) and a urethane bond, the crystalline polyurethane resin (a2), a resin formed of only a crystalline resin (x) having a urethane bond, and a block resin formed of a crystalline portion (x) and a non-crystalline resin (y) which is bonded with the crystalline portion (x) by urethane bond are included.

Each of the two or more kinds of crystalline resins preferably has a total endothermic amount of from 20 J/g to 150 J/g, preferably from 30 J/g to 120 J/g, and particularly preferably from 40 J/g to 100 J/g in terms of high temperature stabililty.

The total endothermic amount of a crystalline resin can be measured by the following method.

Method of Measuring Total Endothermic Amount ΔH of Crystalline Resin

To measure the total endothermic amount AH of a crystalline resin, a differential scanning calorimeter (DSC Q1000, manufactured by TA Instruments. Japan) is used under the following condition.

Heating speed: 10° C./min

### Measuring Starting Temperature: 20° C.

Measuring Ending temperature: 180° C.

The melting points of indium and zinc are used to correct the temperature of the detector unit of the device. The melting heat of indium is used to correct the heat amount. To be specific, about 5 mg of a sample was precisely weighed and placed in a silver pan followed by measuring endothermic amount once to obtain a DSC curve. ΔH is obtained by this DSC curve. The silver pan is used as reference.

The crystalline resin of the present disclosure preferably has an Mn of from 1,000 to 5,000,000 and more preferably from 2,000 to 500,000.

Mn and Mw of the resin in the present disclosure can be measured by gel permeation chromatography (GPC), for example, under the following conditions and devices:
Device: HLC-8120, manufactured by Tosoh Corporation
Column: TSK GEL GMH3, manufactured by Tosoh Corporation, two columns

### Measuring Temperature: 40° C.

Sample Solution: 0.25% by weight tetrahydrofuran solution (obtained by filtering undissolved portion with a glass filter

Poured Amount of Solution: 100 μm

Detecting Device Refraction index detector

Reference Material Standard polystyrene (TSKstandard POLYSTYRENE) 12 materials (molecular weight: 500, 1,050, 2,800, 5,970, 9,100, 18,100, 37,900, 96,400, 190,000, 355,000, 1,090,000, and 2,890,000, manufactured by Tosoh Corporation.

The crystalline resin preferably has a solubility parameter (root square of agglomerating energy, hereinafter referred to as SP value) of from 7 (cal/cm³)^{1/2} to 18 (cal/cm³)^{1/2}, more preferably from 8 (cal/cm³)^{1/2} to 16 (cal/cm³)^{1/2}, and particularly from 9 (cal/cm³)^{1/2} to 14 (cal/cm³)^{1/2}.

The SP value in the present disclosure is calculated according to the method by Fedors (Polym. Eng. Sci. 14(2)152, published in 1974.

The glass transition temperature (hereinafter referred to as Tg) of the crystalline resin is preferably from 20° C. to 200° C. and more preferably from 40° C. to 150° C. Tg of a crystalline resin can be measured by using DSC20 SSC/580, manufactured by SEICO Electronics Industrial Co., Ltd.) according to the method (DSC) regulated in ASTM D3418-82.

In the toner of the present disclosure, the binder resin is formed the two or more kinds of crystalline resins with the non-crystalline resin (b).

The content of the two or more crystalline resins in the binder resin is preferably from 51% by weight or more, more preferably from 60% by weight or more, and particularly preferably from 70% by weight or more.

The non-crystalline resin (b) can be prepared from its precursor (b0).

There is no specific limit to the precursor (b0) that forms the non-crystalline resin (b) by chemical reaction. If the non-crystalline resin (b) is a non-crystalline polyester resin (b1), a non-crystalline polyurethane resin (b2), a non-crystalline polyurea resin (b3) or a non-crystalline epoxy resin (b5), the precursor (b0) is, for example, a combination of a prepolymer (α) having a reactive group and a curing agent (β).

If the non-crystalline resin (b) is a vinyl resin (b4), the monomers (5) to (10) can be used as the precursor (b0).

Of these precursors (b0), the combination of a prepolymer (α) having a reactive group and a curing agent (13) is preferable in terms of productivity.

The reactive group in the prepolymer (α) when the combination of a prepolymer (α) having a reactive group and a curing agent (13) is used as the precursor (b0) means a group reactive with the curing agent (β). The non-crystalline resin (b) is formed by, for example, conducting reaction by heating the prepolymer (α) and the curing agent (β) as the method of forming the non-crystalline resin (b) by reacting the precursor (b0).

Specific examples of the combination of the prepolymer (α) having a reactive group and the curing agent (β) include, but are not limited to, (1) and (2).

(1): combination of a reactive group (α1) and a curing agent (β1): (a reactive group (α1) is reactive with an active hydrogen compound and a curing agent (β1) has an active hydrogen group).

(2): combination of a reactive group (α2) and a curing agent (β2): (a reactive group (α2) is reactive with an active hydrogen compound and a curing agent (β2) is a compound reactive with an active hydrogen group).

In the combination of (1), specific examples of the reactive group (α1) include, but are not limited to, an isocyante group (α1a), a blocked isocyanate group (α1b), an epoxy group (α1c), an anhydride group (α1d), and an acid halide group (α1e). Of these, isocyante group (α1a), blocked isocyanate group (α1b), and epoxy group (α1c) are preferable and isocyante group (α1a) and blocked isocyanate group (α1b) are more preferable.

The blocked isocyanate group (α1b) means an isocyante group blocked by a blocking agent.

Specific examples of the blocking agents include, but are not limited to, oximes (such as acetoxime, methyl isobutyl ketoxime, diethylketoxime, cyclopentanone oxime, cyclohexanone oxime, and methylethyl ketoxime); lactams (such as γ-butylo lactam, ε-caprolactam, and γ-valerolactam); aliphatic alcohols having 1 to 20 carbon atoms (such as ethanol and octanol); phenols (such as phenol, m-cresol, xylenol, and nonyl phenol); active methylene compounds (acetylacetone, ethyl malonate, and acetoethyl acetate); basic nitrogen-containing compounds (N,N-diethyl hydroxylamine, 2-hydroxy pyridine, pyridine N-oxide, and 2-mercapto pyridine); and mixtures thereof.

Of these, oximes are preferable and methylethyl ketoxime is more preferable.

Specific examples of the constitution units of the prepolymer (α) having a reactive group include, but are not limited to, polyethers (αv), polyesters (αw), epoxy resins (αx), polyurethanes (αy), and polyureas (αz).

Specific examples of the polyethers (αv) include, but are not limited to, polyethylene oxide, polypropylene oxide, and polybutylene oxide.

A specific example of the polyesters (αv) is a non-crystalline polyester resin (B1). Specific examples of the epoxy resins (αx) include, but are not limited to, addition condensed compounds of bisphenols (such as bisphenol A, bisphenol F, and bisphenol S) with epichlorohydrin.

Specific examples of the polyurethane (αy) include, but are not limited to, polyaddition compounds of diols (1) and diisocyanate (4) and polyaddition compounds of polyesters (αw) and diisocyanates (4).

Specific examples of the polyurea (αz) include, but are not limited to, polyaddition compounds of diamines (3) and diisocyanates (4).

Specific examples of methods of introducing a reactive group into polyethers (αv), polyesters (αw), epoxy resins (αx), polyurethanes (αy), and polyureas (αz) include, but are not limited to:

(1): a method of having the functional group of a constituting portion of two or more constituting portions remain at an end by using the constituting portion in an excessive amount relative to the others.

(2): a method of having the functional group of a constituting portion of two or more constituting portions remain at an end by using the constituting portion in an excessive amount relative to the others followed by conducting reaction of a compound having a functional group reactive with the remaining functional group or a reactive group therewith.

What is obtained in the method of (1) is, for example, a polyester prepolymer having a hydroxy group, a polyester prepolymer having a carboxyl group, a polyester prepolymer having an acid halide group, a prepolymer of an epoxy resin containing a hydroxy group, a prepolymer of an epoxy resin containing an epoxy group, a polyurethane prepolymer having a hydroxy group, and a polyurethane prepolymer having an isocyanate group.

With regard to the ratio of the constituting components, for example, in a case of a polyester prepolymer having a hydroxy group, the ratio of the polyol component to the polycarboxylic acid component is from 2/1 to 1/1, more preferably from 1.5/1 to 1/1, and particularly from 1.3/1 to 1.02/1 as the equivalent ratio of the hydroxy group [OH] to the carboxylic group [COOH]. In cases of other skeletons and/or terminal groups, since simply the constituting components are different, the ratio is the same.

What is obtained in the method of (2) is, for example, a prepolymer having an isocyanate group by reacting with the prepolymer obtained in the method (1) with a polyisocyanate, a prepolymer having a blocked isocynate group by reacting with a blocked polyisocyanate, a prepolymer having an epoxy group by reacting with a polyepoxide, and a prepolymer having an acid anhydride group by reacting with a polyacid anhydride.

With regard to the usage amount of the compound having a functional group and a reactive group is, for example, in a case in which a polyester prepolymer having an isocyanate group is obtained by reacting a polyester prepolymer having a hydroxy group with a polyisocyanate, the ratio of the polyisocyanate represented by the equivalent ratio of the isocyanate group [NCO] to the hydroxy group [OH] of the polyester prepolymer having a hydroxy group is preferably from 5/1 to 1/1, more preferably from 4/1 to 1.2/1, and particularly preferably from 2.5/1 to 1.5/1. In cases of other skeletons and/or terminal groups, since simply the constituting components are different, the ratio is the same.

The number of the reactive groups contained per molecule of the prepolymer (α) having a reactive group is preferably 1 or more, more preferably from 1.5 to 3 on the average, and particularly preferably from 1.8 to 2.5 on the average. The molecular weight of the cured material obtained by reaction with the curing agent (β) is increased by setting the number within the range specified above.

The prepolymer (α) having a reactive group preferably has an Mn of from 500 to 30,000, more preferably from 1,000 to 20,000, and particularly preferably from 2,000 to 10,000.

The prepolymer (α) having a reactive group preferably has an Mw of from 1,000 to 50,000, more preferably from 2,000 to 40,000, and particularly preferably from 4,000 to 20,000.

Specific examples of the curing agent (β1) having an active hydrogen group include, but are not limited to, a diamine (β1a) which may be blocked by a detachable compound, a diol (β1b), a dimercaptane (β1c), and water. Of these, the diamine (β1a) which may be blocked by a detachable compound, the diol (β1b), and water are preferable. The diamine (β1a) which may be blocked by a detachable compound and water are more preferable. Blocked polyamines and water are particularly preferable.

Specific examples of the diamine (β1a) which may be blocked by a detachable compound include, but are not limited to, the same as for the diamine (3). Preferable specific examples of the diamine (β1a) which may be blocked by a detachable compound include, but are not limited to, 4,4″-diaminodiphenyl methane, xylylene diamine, isophorone diamine, ethylene diamine, diethylene triamine, triethylene tetramine, and mixtures thereof.

Specific examples of the diol (β1b) include, but are not limited to, the same as for the diol (1) and the preferable range is also the same as therefor.

Specific examples of the dimercaptane (β1c) include, but are not limited to, ethane dithiol, 1,4-butane dithiol, 1,4-butane dithiol, and 1,6-hexane dithiol.

It is possible to use a reaction terminator Ws) together with the curing agent (β1) having an active hydrogen group. By using the reaction terminator (βs) in combination with the curing agent (β1) having an active hydrogen group in a fixed ratio, it is possible to obtain a non-crystalline resin (b) having a predetermined molecular weight.

Specific examples of the reaction terminator (βs) include, but are not limited to, monoamine (such as diethylamine, dibutyl amine, butyl amine, lauryl amine, monoethanol amine, and diethanol amine); blocked compounds in which monoamines are blocked (such as ketiminie compounds); monools (such as methanol, ethanol, isopropanol, butanol, and phenol); monomeracaptanes (such as butyl mercaptane and lauryl mercaptane); monoisocyanates (such as lauryl isocyanates and phenyl isocyanates); and monoepoxides (such as butyl glycidyl ether).

Specific examples of the active hydrogen containing group (α2) of the prepolymer (α) having a reactive group in the combination of (2) include, but are not limited to, an amino group (α2a), a hydroxy group (α2b) (alcoholic hydroxyl group and a phenolic hydroxy group), a meracapto group (α2c), a carboxylic group (α2d), and an organic group (α2e) in which these are blocked by a detachable compound. Of these, the amino group (α2a), the hydroxy group (α2b), and the organic group (α2e) are preferable and the hydroxy group (α2b) is more preferable.

A specific example of the organic group in which an amino group is blocked by a detachable compound is the same as for the diamine (β1a) which may be blocked by a detachable compound.

Specific examples of the compound reactive with an active hydrogen group include, but are not limited to, diisocyanates (β2a), polyepoxides (β2b), polycarboxylic acids (β2c), polyacid hydrides (β2d), and polyacid halide (β2e). Of these, the diisocyanates (β2a) and the polyepoxides (β2b) are preferable. The diisocyanates (β2a) are more preferable.

Specific examples of the diisocyanates (β2a) include, but are not limited to, the same as for the diisocyanates (4) and the preferable examples thereof are also the same as therefor.

Specific examples of the diepoxides (β2b) include, but are not limited to, the same as for the polyepoxides (14).

Specific examples of the dicarboxylic acids (β2c) include, but are not limited to, the same as for the dicarboxylic acids (2) and the preferable examples thereof also the same as therefor.

The ratio of the curing agent (β) represented as the equivalent ratio of the equivalent amount (α) of the reactive group in the prepolymer (α) having a reactive group to the equivalent amount (β) of the active hydrogen group in the curing agent (β) is preferably from 1/2 to 2/1, more preferably from 1.5/1 to 1/1.5, and particularly preferably from 1.2/1 to 1/1.2. When the curing agent (β) is water, water is treated as a divalent active hydrogen compound.

The toner of the present disclosure contains a binder resin (toner binder).

The toner of the present disclosure contains a coloring agent and other optional compounds such as a releasing agent, a charge control agent, and a fluidizer.

Dyes and pigments used as coloring agents for toner can be used.

Specific examples thereof include, but are not limited to, carbon black, iron black, Sudan black SM, fast yellow G, Benzidine Yellow, Solvent Yellow (21, 77, 114, etc.), Pigment Yellow (12, 14, 17, 83, etc.), Indo Fast Orange, Irgadine Red, Paranitroaniline Red, Toluidine Red, Solvent Red (17, 49, 128, 5, 13, 22, 48.2, etc.), Disperse Red, Carmine FB, Pigment Orange R, Lake Red C, Rhodamine FB, Rhodamine B Lake, Methyl Violet B Lake, Phthalocyanine Blue, Irgadine Red, Paranitroaniline Red, Toluidine Red, Solvent Blue (25, 94, 60, 15•3, etc.), PigmentBlue, Brilliant Green, Phthalocyanine Green, OilYellow GG, Kayaset YG, Orazole Brown B, and Oil Pink OP. These can be used alone or in combination.

Optionally, magnetic powder (such as powder of ferromagnetic metal such as iron, cobalt, and nickel, compounds such as magnetite, hematite, and ferrite, etc.) can be added also serving as coloring agent.

The content ratio of the coloring agent is preferably from 0.1 parts by weight to 40 parts by weight and more preferably from 0.5 parts by weight to 10 parts by weight based on 100 parts by weight of the binder resin of toner. When using magnetic powder, it is preferably from 20 parts by weight to 150 parts by weight and more preferably from 40 parts by weight to 120 parts by weight.

As the releasing agent, releasing agents having a softening point of from 50° C. to 170° C. are preferable. Specific examples thereof include, but are not limited to, polyolefin waxes, natural waxes, (e.g., carnauba wax, montan wax, paraffin wax, and rice wax); aliphatic alcohols having 30 to 50 carbon atoms (e.g., triacontanol); aliphatic acids having 30 to 50 carbon atoms (e.g., triacontan carboxylic acid); and mixtures thereof.

Specific examples of such polyolefin waxes include, but are not limited to, (co)polymers (including polymer obtained by (co)polymerization and therramally degraded polyolefins) of olefins (such as ethylene, propylene, 1-butene, isobutylene, 1-hexene, 1-dodecene, 1-octadecen, and mixtures thereof); oxides of (co)polymers of olefins by oxygen and/or ozone; (co)polymers of olefin, which are modified by maleic acid (such as maleic acid and derivatives thereof such as maleic anhydride, monomethyl maleate, monobutyl maleate, dimethyl maleate); copolymers of olefins and unsaturated carboxylic acids (such as (meth)acrylic acid, itaconic acid, and maleic anhydride) and/or unsaturated carboxylic acid alkyl esters (such as (meth)acrylic acid alkyl (having 1 to 18 carbon atoms) esters and maleic acid alkyl (having 1 to 18 carbon atoms) esters); polymethylenes (such as Fischer-Tropsch waxes such as Sasol Wax); aliphatic acid metal salts (calcium stearate); and aliphatic acid esters (such as behenyl behenate).

Specific examples of the charge control agent include, but are not limited to, Nigrosine dyes, triphenyl methane-based dyes containing tertiary amine as its side chain, quaternary ammonium salts, polyamine resins, imidazole derivatives, polymers containing quaternary ammonium salt group, azo dyes containing metal, copper phthalocyanine dyes, salicylic acid metal salts, boron complex of benzyl acid, polymers containing sulfonic acid group, polymers containing fluorine, polymers having a halogen-substituted aromatic ring, metal complexes of alkyl derivatives of salicylic acid, and cetyl trimethyl ammonium bromide.

Specific examples of the fluidizers include, but are not limited to, colloidal silica, alumina powder, titanium oxide powder, barium titanate, magnesium titanate, calcium titanate, strontium titanate, zinc oxide, quartz sand, clay, mica, sand-lime, diatom earth, chromium oxide, cerium oxide, red iron oxide, antimony trioxide, magnesium oxide, zirconium oxide, barium sulfate, and barium carbonate.

The content ratios of each component constituting the toner of the present disclosure are as follows:

The content ratio of the binder resin is preferably from 30% by weight to 97% by weight, more preferably from 40% by weight to 95% by weight, and particularly preferably from 45% by weight to 92% by weight based on the weight of toner.

The content ratio of the coloring agent is preferably 60% by weight or less, more preferably from 0.1% by weight to 55% by weight, and particularly preferably from 0.5% by weight to 50% by weight based on the weight of toner.

The content ratio of the releasing agent is preferably from 0% by weight to 30% by weight, more preferably from 0.5% by weight to 20% by weight, and particularly preferably from 1% by weight to 10% by weight based on the weight of toner.

The content ratio of the charge control agent is preferably from 0% by weight to 20% by weight, more preferably from 0.1% by weight to 10% by weight, and particularly preferably from 0.5% by weight to 7.5% by weight based on the weight of toner. The content ratio of the fluidizer is preferably from 0% by weight to 10% by weight, more preferably from 0% by weight to 5% by weight, and particularly preferably from 0.1% by weight to 4% by weight based on the weight of toner.

The toner of the present disclosure can be mixed with carrier particles (such as iron powder, glass beads, nickel powder, ferrite, magnetite, ferrite covered with resins such as acrylic resins and silicone resins) to be used as a development agent for latent electrostatic images. Also, instead of carrier particles, toner can be frictioned with a charging blade, etc. to form a latent electrostatic image. Such a latent electrostatic image can be fixed on a substrate (typically paper, polyester film, etc.) by a known heat roll fixing method.

The volume average particle diameter (hereinafter referred to as D50) of the toner particle of the present disclosure is preferably from 1 μm to 15 μm, more preferably from 2 μm to 10 μm, and particularly preferably from 3 μm to 7 μm.

The volume average particle diameter of the toner particle of the present disclosure can be measured by Coulter Counter (Multisizer III, manufactured by Beckman Coulter Inc.).

There is no specific limit to the method of manufacturing the toner of the present disclosure. The toner can be manufactured by known methods such as a kneading-pulverization method, an emulsification phase change method, a polymerization method.

For example, when preparing toner by a kneading-pulverization method, the toner can be manufactured by: dry blending the components of toner excluding a fludiizer; melt-kneading the blended material followed by coarse pulverization; microparticulating the coarse-pulverized materials by a jet mill pulverizer, etc. followed by classification to obtain particulates having a volume average particle diameter of from 1 μm to 15 μm; and mixing a fluidizer with the particulates. When preparing toner by an emulsification phase change method, after dissolving or dispersing the components of toner excluding a fludizer in an organic solvent, water is added for emulsification followed by separation and classification to obtain the toner. Also, a method is suitable which uses organic particles disclosed in JP-2002-284881-A.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but not limited thereto.

### Manufacturing Example 1

### Synthesis of Crystalline Polyester Resin a1-1

881 parts of dodecanedionic acid, 475 parts of ethylene glycol, and 0.1 parts of dibutyl tin oxide were placed in a reaction container equipped with a stirrer, a heating and cooling device, a thermometer, a nitrogen-introducing tube, and a decompression device while introducing nitrogen into the container. Subsequent to nitrogen replacement by decompression operation, the system was heated to 180° C. and stirred at the same temperature for six hours. Thereafter, by gradually heating the system to 230° C. under a reduced pressure of from 0.007 Mpa to 0.026 MPa while being stirred, the system was maintained at the same temperature for two hours. When the resultant became tenacious, it was cooled down to 150° C. to cease the reaction. Thus, [Crystalline polyester resin a1-1] was obtained.

### Manufacturing Example 2

### Synthesis of Crystalline Polyester Resin a1-2

[Crystalline polyester resin a1-2] was obtained in the same manner as in Manufacturing Example 1 except that 881 parts of dodecanedionic acid was changed to 684 parts of sebacic acid and 475 parts of ethylene glycol was changed to 437 parts of 1,6-hexane dial.

### Manufacturing Example 3

### Synthesis of Crystalline Polyester Resin a1-3

[Crystalline polyester resin a1-3] was obtained in the same manner as in Manufacturing Example 1 except that 881 parts of dodecanedionic acid was changed to 868 parts of sebacic acid and 475 parts of ethylene glycol was changed to 532 parts.

### Manufacturing Example 4

### Synthesis of Crystalline Polyurethane Resin a2-1

216.0 parts of [Crystalline polyester a1-2], 64.0 parts of diphenyl methane diisocyanate, 20.0 parts of 1,2-propylene glycol, and 300.0 parts of tetrahydrofuran (THF) were placed in a reaction container equipped with a stirrer, a heating and cooling device, a thermometer, a nitrogen-introducing tube, and a decompression device while introducing nitrogen into the container. By heating the system to 50° C., urethanification reaction was conducted at the same temperature for 15 hours to obtain THF solution of [Crystalline polyurethane a2-1] having a hydroxy group at its end. By distilling THF away, [Crystalline polyurethane resin a2-1] was obtained.

[Crystalline polyurethane a2-1] contained no [NCO] (0% by weight).

### Manufacturing Example 5

### Synthesis of Crystalline Polyurethane Resin a2-2

290.0 parts of [Crystalline polyester a1-2], 10.0 parts of hexamethylene diisocyanate, and 300.0 parts of tetrahydrofuran (THF) were placed in a reaction container equipped with a stirrer, a heating and cooling device, a thermometer, a nitrogen-introducing tube, and a decompression device while introducing nitrogen into the container. By heating the system to 50° C., urethanification reaction was conducted at the same temperature for 15 hours to obtain THF solution of [Crystalline polyurethane resin a2-2] having a hydroxy group at its end. By distilling THF away, [Crystalline polyurethane resin a2-2] was obtained. [Crystalline polyurethane resin a2-2] contained no [NCO] (0% by weight).

### Manufacturing Example 6

### Synthesis of Crystalline Polyurethane Resin a2-3

372.0 parts of parts of [Crystalline polyester a1-1], 29.6 parts of 2,2-dimethylol propinoic acid, 2.4 parts of 3-(2,3-dihydroxy propoxy)-1-propane sodium sulfonate, 93.7 parts of isophorone diisocyanate, and 500 parts of acetone were placed in a reaction container equipped with a stirrer, a heating and cooling device, a thermometer, a nitrogen-introducing tube, and a decompression device while introducing nitrogen into the container.

By heating the system to 90° C., urethanification reaction was conducted at the same temperature for 40 hours to obtain acetone solution of [Crystalline polyurethane a2-3] having a hydroxy group at its end. By distilling acetone away, [Crystalline polurethane resin a2-3] was obtained. [Crystalline polyurethane a2-3] contained no [NCO] (0% by weight).

### Manufacturing Example 7

### Manufacturing of Crystalline Polyurethane Resin a2-4

150.0 parts of polyester diol (Sanester 4620, manufactured by Sanyo Chemical Industries, Ltd.) formed of 1,4-butane diol and adipic acid, 60.0 parts of xylylene diisocyanate, 90.0 parts of an adduct of bisphenol A with 2 mols of PO, and 300.0 parts of tetrahydrofuran (THF) were placed in a reaction container equipped with a stirrer, a heating and cooling device, a thermometer, a nitrogen-introducing tube, and a decompression device while introducing nitrogen into the container. By heating the system to 50° C., urethanification reaction was conducted at the same temperature for 15 hours to obtain THF solution of [Crystalline polyurethane a2-4] having a hydroxy group at its end.

By distilling THF away, [Crystalline polyurethane a2-4] was obtained. [Crystalline polyurethane a2-4] contained no [NCO] (0% by weight).

### Manufacturing Example 8

### Manufacturing of Crystalline Vinyl Resin a3-1

50 parts of THF was placed in a reaction container equipped with a stirrer, a heating and cooling device, a thermometer, a dripping funnel, and a nitrogen-introducing tube. 75 parts of behenyl acrylate, 15 parts of acrylic acid, 10 parts of methyl methacrylate, 50 parts of THF, 0.2 parts of 2,2′-azobis(2,4-dimethyl valeronitrile) were placed in a glass beaker followed by stirring and mixing at 40° C. to prepare a monomer solution, which was put into the dripping funnel. After nitrogen replacement of the gas phase portion of the reaction container, the monomer solution was dripped at 70° C. in two hours while being sealed. Subsequent to aging at 70° C. for 6 hours after the dripping, THF solution of [Crystalline vinyl resin a3-1] was obtained. Thereafter, THF was distilled away to obtain [Crystalline vinyl resin a3-1].

### Manufacturing Example 9

### Synthesis of Polyester Resin b-1

475 parts (60.5 mol %) of terephtalic acid, 120 parts (15.1 mol %) of isophthalic acid, 105 parts (15.1 mol %) of adipic acid, 300 parts (50.0 mol % considering 157 parts were retrieved as described below) of ethylene glycol, 240 parts (50.0 mol %) of neopentyl glycol, and 0.5 parts of titanium diisopropoxy bistriethanol aminate serving as polymerization catalyst were placed in a reaction container equipped with a stirrer, a heating and cooling device, a thermometer, a nitrogen-introducing tube, and a decompression device to conduct reaction at 210° C. for 5 hours while distilling away water produced in nitrogen atmosphere followed by one-hour reaction with a reduced pressure of from 0.007 MP to 0.026 MPa. Thereafter, 7 parts (1.2 mol %) of benzoic acid was added thereto to conduct reaction at 210° C. under normal pressure for three hours. Furthermore, 73 parts (8.0 mol %) of trimellitic anhydride was added to the container to conduct reaction at 210° C. under normal pressure for one hour. Subsequent to reaction under a reduced pressure of from 0.026 MP to 0.052 MPa, when Tm reached 145° C., the resultant was taken out to obtain [Polyester resin b-1]. [Polyester resin b-1] had an Mw of 8,000, a Tg of 60° C., an acid value of 26, a hydroxy group value of 1, and an SP value of 11.8 (cal/cm³)^{1/2}.

The content of ethylene glycol retrieved was 157 parts.

Mol % in parentheses represents mol % of each material in a carboxylic acid component or a polyol component.

### Manufacturing Example 10

### Synthesis of Polyester Resin b-2

440 parts (54.7 mol %) of terephtalic acid, 235 parts (28.3 mol %) of isophthalic acid, 7 parts (1.0 mol %) of adipic acid, 30 parts (5.1 mol %) of benzoic acid, 554 parts of ethylene glycol, and 0.5 parts of tetrabuthoxy titanate serving as a polymerization catalyst were placed in a reaction container equipped with a stirrer, a heating and cooling device, a thermometer, a nitrogen-introducing tube, and a decompression device to conduct reaction at 210° C. for 5 hours while distilling away water and ethylene glycol produced in nitrogen atmosphere followed by one-hour reaction with a reduced pressure of from 0.007 MP to 0.026 MPa. Furthermore, 103 parts (10.9 mol %) of trimellitic anhydride was added to the container to conduct reaction at 210° C. under normal pressure for one hour. Subsequent to reaction under a reduced pressure of from 0.026 MP to 0.052 MPa, when Tm reached 138° C., the resultant was taken out to obtain [Polyester resin b-2]. [Polyester resin b-2] had an Mw of 4,900, a Tg of 56° C., an acid value of 35, a hydroxy group value of 28, a THF insoluble portion of 5% by weight, and an SP value of 12.4 (cal/cm³)^{1/2}. The content of ethylene glycol retrieved was 219 parts.

### Manufacturing Example 11

### Synthesis of Polyester Resin b-3

567 parts (68.0 mol %) of terephtalic acid, 243 parts (30.0 mol %) of isophthalic acid, 243 parts (15.1 mol %) of adipic acid, 605 parts (85.0 mol % considering 334 parts were retrieved as described below) of ethylene glycol, 80 parts (15.0 mol %) of neopentyl glycol, and 0.5 parts of titanium diisopropoxy bistriethanol aminate were placed in a reaction container equipped with a stirrer, a heating and cooling device, a thermometer, a nitrogen-introducing tube, and a decompression device to conduct reaction at 210° C. for 5 hours while distilling away water and ethylene glycol produced in nitrogen atmosphere. Furthermore, 16 parts (2.0 mol %) of trimellitic anhydride was added to the container to conduct reaction under normal pressure for one hour. Subsequent to reaction under a reduced pressure of from 0.026 MP to 0.052 MPa, when Tm reached 138° C., the resultant was taken out to obtain [Polyester resin b-3]. [Polyester resin b-3] had an Mw of 17,000, a Tg of 61° C., an acid value of 1, a hydroxy group value of 14, a THF insoluble portion of 3% by weight, and an SP value of 12.1 (cal/cm³)^{1/2}. The content of ethylene glycol retrieved was 334 parts.

### Manufacturing Example 12

### Synthesis of Crystalline Polyester Resin a′-1

574 parts of terephthalic acid, 64 parts of isophthalic acid, 500 parts of 1,6-hexane diol, and 0.1 parts of dibutyl tin oxide were placed in a reaction container equipped with a stirrer, a heating and cooling device, a thermometer, a nitrogen-introducing tube, and a decompression device while introducing nitrogen into the container. Subsequent to nitrogen replacement by decompression operation, the system was heated to 180° C. and stirred at the same temperature for six hours. Thereafter, by gradually heating the system to 230° C. under a reduced pressure of from 0.007 MPa to 0.026 MPa while being stirred, the system was maintained at the same temperature for two hours. When the resultant became tenacious, it was cooled down to 150° C. to cease the reaction. Thus, [Crystalline polyester resin a′-1] was obtained.

### Manufacturing Example 13

### Synthesis of Crystalline Polyester Resin a′-2

379 parts of terephthalic acid, 333 parts of adipic acid, 452 parts of 1,4-butane diol, and 0.1 parts of dibutyl tin oxide were placed in a reaction container equipped with a stirrer, a heating and cooling device, a thermometer, a nitrogen-introducing tube, and a decompression device while introducing nitrogen into the container. Subsequent to nitrogen replacement by decompression operation, the system was heated to 180° C. and stirred at the same temperature for six hours. Thereafter, by gradually heating the system to 230° C. under a reduced pressure of from 0.007 MPa to 0.026 MPa while being stirred, the system was maintained at the same temperature for two hours.

When the resultant became tenacious, it was cooled down to 150° C. to cease the reaction. Thus, [Crystalline polyester resin a′-2] was obtained.

### Manufacturing Example 14

### Synthesis of Polyester Resin b-4

252 parts (85.1 mol %) of terephtalic acid, 14 parts (5.2 mol %) of adipic acid, 757 parts (100.0 mol %) of an adduct of bisphenol A with 2 mols of PO, and 0.5 parts of titanium diisopropoxy bistriethanol aminate were placed in a reaction container equipped with a stirrer, a heating and cooling device, a thermometer, a nitrogen-introducing tube, and a decompression device to conduct reaction at 225° C. for 5 hours while distilling away water produced in nitrogen atmosphere. Furthermore, 33 parts (9.7 mol %) of trimellitic anhydride was added to the container to conduct reaction under normal pressure for one hour. Subsequent to reaction under a reduced pressure of from 0.026 MP to 0.052 MPa, when Tm reached 120° C., the resultant was taken out to obtain [Polyester resin b-4]. [Polyester resin b-4] had an Mw of 4,900, a Tg of 63° C., an acid value of 18, a hydroxy group value of 53, a THF insoluble portion of 2% by weight, and an SP value of 11.2 (cal/cm²)^{1/2}.

Properties of crystalline resins a1-1 to a1-3, a2-1 to a2-4, a3-1, b-1 to b-4, and a′-1 to a′-2 obtained in Manufacturing Examples 1 to 14 are shown in Tables 1 and 2.

TABLE 1

| | Crystalline resin | | | | | | | | | |
|---|---|---|---|---|---|---|---|---|---|---|
| | a1-1 | a1-2 | a1-3 | a2-1 | a2-2 | a2-3 | a2-4 | a3-1 | a′-1 | a′-2 |
| Ta (° C.) | 84 | 67 | 72 | 60 | 65 | 74 | 45 | 64 | 123 | 106 |
| total | 150 | 120 | 100 | 60 | 80 | 40 | 60 | 60 | 60 | 50 |
| endothermic | | | | | | | | | | |
| amount (J/g) | | | | | | | | | | |
| Content ratio | 100 | 100 | 100 | 72 | 95 | 74 | 50 | 75 | 100 | 100 |
| (% by | | | | | | | | | | |
| weight) of | | | | | | | | | | |
| crystalline | | | | | | | | | | |
| unit (x) | | | | | | | | | | |
| Mw | 20000 | 12000 | 6000 | 30000 | 30000 | 50000 | 10000 | 30000 | 6300 | 15000 |
| Ester group | Yes | Yes | Yes | Yes | Yes | Yes | Yes | Yes | Yes | Yes |
| Urethane | No | No | No | Yes | Yes | Yes | Yes | No | No | No |
| group | | | | | | | | | | |
| Urea group | No | No | No | Yes | Yes | Yes | Yes | No | No | No |

TABLE 2

b

| | b-1 | b-2 | b-3 | b-4 |
|---|---|---|---|---|
| Tg (° C.) | 60 | 56 | 61 | 63 |
| Mw | 8,000 | 4,900 | 17,000 | 4,900 |
| Acid value | 26 | 35 | 1 | 18 |
| Hydroxy value | 1 | 28 | 14 | 53 |

### Manufacturing Example 15 of Binder Resin

[Crystalline polyester resin a1-1] obtained in Manufacturing Example 1, [Crystalline polyurethane resin a2-1] obtained in Manufacturing Example 4, and [Non-crystalline resin b-1] obtained in Manufacturing Example 9 were mixed according to the mixing ratio (based on parts) shown in Table 3 to obtain [Binder resin R-1].

### Manufacturing Example 16 of Binder Resin

[Crystalline polyester resin a1-1] obtained in Manufacturing Example 1 and [Crystalline polyester resin a1-3] obtained in Manufacturing Example 3 were mixed according to the mixing ratio (based on parts) shown in Table 3 to obtain [Binder resin R-2].

### Manufacturing Example 17 of Binder Resin

[Crystalline polyester resin a1-1] obtained in Manufacturing Example 1 and [Crystalline polyurethane resin a2-1] obtained in Manufacturing Example 4 were mixed according to the mixing ratio (based on parts) shown in Table 3 to obtain [Binder resin R-3].

### Manufacturing Example 18 of Binder Resin

[Crystalline polyester resin a1-1] obtained in Manufacturing Example 1, [Crystalline polyurethane resin a2-1] obtained in Manufacturing Example 4, and [Non-crystalline polyester resin b-2] obtained in Manufacturing Example 10 were mixed according to the mixing ratio (based on parts) shown in Table 3 to obtain [Binder resin R-4].

### Manufacturing Example 19 of Binder Resin

[Crystalline polyester resin a1-1] obtained in Manufacturing Example 1, [Crystalline polyurethane resin a2-1] obtained in Manufacturing Example 4, and [Non-crystalline polyester resin b-3] obtained in Manufacturing Example 11 were mixed according to the mixing ratio (based on parts) shown in Table 3 to obtain [Binder resin R-5].

### Manufacturing Example 20 of Binder Resin

[Crystalline polyurethane resin a2-1] obtained in Manufacturing Example 4, [Crystalline polyurethane resin a2-2] obtained in Manufacturing Example 5, and [Crystalline resin a3-1] obtained in Manufacturing Example 8 were mixed according to the mixing ratio (based on parts) shown in Table 3 to obtain [Binder resin R-6].

### Manufacturing Example 21 of Binder Resin

[Crystalline polyurethane resin a2-2] obtained in Manufacturing Example 5, [Crystalline polyurethane resin a2-3] obtained in Manufacturing Example 6, and [Crystalline resin a3-1] obtained in Manufacturing Example 8 were mixed according to the mixing ratio (based on parts) shown in Table 3 to obtain [Binder resin R-7].

### Manufacturing Example 22 of Binder Resin

[Crystalline polyester resin a1-1] obtained in Manufacturing Example 1 and [Crystalline polyurethane resin a2-4] obtained in Manufacturing Example 7 were mixed according to the mixing ratio (based on parts) shown in Table 3 to obtain [Binder resin R-8].

### Manufacturing Example 23 of Binder Resin

[Crystalline polyester resin a1-1] obtained in Manufacturing Example 1, [Crystalline polyurethane resin a2-1] obtained in Manufacturing Example 4, and [Non-crystalline polyester resin b-1] obtained in Manufacturing Example 9 were mixed according to the mixing ratio (based on parts) shown in Table 3 to obtain [Binder resin R-9].

### Manufacturing Example 24 of Binder Resin

[Crystalline polyester resin a1-1] obtained in Manufacturing Example 1, [Crystalline polyester resin a1-2] obtained in Manufacturing Example 2, [Crystalline polyester resin a1-3] obtained in Manufacturing Example 3, and [Crystalline polyurethane resin a2-1] obtained in Manufacturing Example 4 were mixed according to the mixing ratio (based on parts) shown in Table 3 to obtain [Binder resin R-10].

### Manufacturing Example 25 of Binder Resin

[Crystalline polyester resin a1-1] obtained in Manufacturing Example 1, [Crystalline polyurethane resin a2-1] obtained in Manufacturing Example 4, and [Non-crystalline resin b-4] obtained in Manufacturing Example 14 were mixed according to the mixing ratio (based on parts) shown in Table 3 to obtain [Binder resin R-11].

### Manufacturing Example 26 of Binder Resin

[Crystalline polyester resin a1-1] obtained in Manufacturing Example 1, [Crystalline polyurethane resin a2-1] obtained in Manufacturing Example 4, and [Non-crystalline polyester resin b-4] obtained in Manufacturing Example 14 were mixed according to the mixing ratio (based on parts) shown in Table 3 to obtain [Binder resin R-12].

### Manufacturing Example 27 of Binder Resin

[Crystalline polyester resin a1-1] obtained in Manufacturing Example 1 and [Crystalline polyester resin a′-1] obtained in Manufacturing Example 12 were mixed according to the mixing ratio (based on parts) shown in Table 3 to obtain [Binder resin R′-1].

### Manufacturing Example 28 of Binder Resin

[Crystalline polyurethane resin a2-4] obtained in Manufacturing Example 7 and [Crystalline resin a′-2] obtained in Manufacturing Example 13 were mixed according to the mixing ratio (based on parts) shown in Table 3 to obtain [Binder resin R′-2].

### Manufacturing Example 29 of Binder Resin

Only [Crystalline polyester resin a1-1] obtained in Manufacturing Example 1 was used as shown in Table 3 to obtain [Binder resin R′-3].

The compositions and thermal properties are shown in Table 3.

TABLE 3

| | | Mfg. | Mfg. | Mfg. | Mfg. | Mfg. |
|---|---|---|---|---|---|---|
| | | Example | Example | Example | Example | Example |
| | | 15 | 16 | 17 | 18 | 19 |
| Binder resin | | R-1 | R-2 | R-3 | R-4 | R-5 |
| Crystalline | a1-1 | 10 | 30 | 15 | 10 | 5 |
| resin | a1-2 | — | — | — | — | — |
| | a1-3 | — | 70 | — | — | — |
| | a2-1 | 50 | — | 85 | 80 | 40 |
| | a2-2 | — | — | — | — | — |
| | a2-3 | — | — | — | — | — |
| | a2-4 | — | — | — | — | — |
| | a3-1 | — | — | — | — | — |
| | a′-1 | — | — | — | — | — |
| | a′-2 | — | — | — | — | — |
| Non- | b-1 | 40 | — | — | — | — |
| crystalline | b-2 | — | — | — | 10 | — |
| resin | b-3 | — | — | — | — | 55 |
| | b-4 | — | — | — | — | — |
| Number of crystalline | | 2 | 2 | 2 | 2 | 2 |
| resins | | | | | | |
| TaMax (° C.) | | 84 | 84 | 84 | 84 | 84 |
| TaMin (° C.) | | 60 | 72 | 60 | 60 | 60 |
| TaMax − TaMin (° C.) | | 24 | 12 | 24 | 24 | 24 |
| Tup (° C.) | | 60 | 70 | 60 | 60 | 60 |
| Tdown (° C.) | | 40 | 67 | 35 | 34 | 34 |
| Tup − Tdown (° C.) | | 20 | 3 | 25 | 26 | 25 |
| | | Mfg. | Mfg. | Mfg. | Mfg. | Mfg. |
| | | Example | Example | Example | Example | Example |
| | | 20 | 21 | 22 | 23 | 24 |
| Binder resin | | R-6 | R-7 | R-8 | R-9 | R-10 |
| Crystalline | a1-1 | — | — | 2 | 10 | 8 |
| resin | a1-2 | — | 1 | — | — | 1 |
| | a1-3 | — | 1 | — | — | 1 |
| | a2-1 | 80 | — | — | 85 | 90 |
| | a2-2 | 15 | 50 | — | — | — |
| | a2-3 | — | 50 | — | — | — |
| | a2-4 | — | — | 98 | — | — |
| | a3-1 | 5 | — | — | — | — |
| | a′-1 | — | — | — | — | — |
| | a′-2 | — | — | — | — | — |
| Non- | b-1 | — | — | 5 | 5 | — |
| crystalline | b-2 | — | — | — | — | — |
| resin | b-3 | — | — | — | — | — |
| | b-4 | — | — | 70 | — | — |
| Number of crystalline | | 3 | 2 | 2 | 2 | 4 |
| resins | | | | | | |
| TaMax (° C.) | | 65 | 74 | 84 | 84 | 84 |
| TaMin (° C.) | | 60 | 65 | 45 | 60 | 60 |
| TaMax − TaMin (° C.) | | 5 | 9 | 39 | 24 | 24 |
| Tup (° C.) | | 60 | 70 | 50 | 60 | 60 |
| Tdown (° C.) | | 35 | 65 | 30 | 35 | 45 |
| Tup − Tdown (° C.) | | 25 | 5 | 20 | 25 | 15 |
| | | Mfg. | Mfg. | Mfg. | Mfg. | Mfg. |
| | | Example | Example | Example | Example | Example |
| | | 25 | 26 | 27 | 28 | 29 |
| Binder resin | | R-11 | R-12 | R′-1 | R′-2 | R′-3 |
| Crystalline | a1-1 | 10 | 2 | 50 | — | 100 |
| resin | a1-2 | — | — | — | — | — |
| | a1-3 | — | — | — | — | — |
| | a2-1 | 20 | 13 | — | — | — |
| | a2-2 | — | — | — | — | — |
| | a2-3 | — | — | — | — | — |
| | a2-4 | — | — | — | 50 | — |
| | a3-1 | — | — | — | — | — |
| | a′-1 | — | — | 50 | — | — |
| | a′-2 | — | — | — | 50 | — |
| Non- | b-1 | 5 | — | — | — | — |
| crystalline | b-2 | — | — | — | — | — |
| resin | b-3 | — | — | — | — | — |
| | b-4 | 70 | 85 | — | — | — |

| | | | | | |
|---|---|---|---|---|---|
| Number of crystalline | 2 | 2 | 2 | 2 | 1 |
| resins | | | | | |
| TaMax (° C.) | 84 | 84 | 123 | 106 | 84 |
| TaMin (° C.) | 60 | 60 | 84 | 45 | 84 |
| TaMax − TaMin (° C.) | 24 | 24 | 39 | 61 | — |
| Tup (° C.) | 60 | 60 | 110 | 100 | 84 |
| Tdown (° C.) | 34 | 45 | 70 | 45 | 80 |
| Tup − Tdown (° C.) | 26 | 15 | 40 | 55 | 4 |

Manufacturing Example 30: Manufacturing of Liquid Dispersion 1 of Particulate

The following recipe was placed in a reaction container equipped with a stirrer, a heating and cooling device, a thermometer, a condenser, and a nitrogen-introducing tube and stirred at 350 rpm for 15 minutes to obtain a white emulsion:

| | |
|---|---|
| Water: | 690.0 parts |
| Sodium salt of sulfuric acid ester of an adduct of | 9.0 parts |
| methacrylic acid with ethyleneoxide (EREMINOR RS-30, | |
| manufactured by Sanyo Chemical Industries, Ltd.): | |
| Styrene: | 90.0 parts |
| Methacrylic acid: | 90.0 parts |
| Butyl acrylate: | 110.0 parts |
| Ammonium persulfate: | 1.0 part. |

Next, the system was heated to 75° C. and reacted at the same temperature for 5 hours. Furthermore, 30 parts of 1% ammonium persulfate aqueous solution was added followed by aging at 75° C. for five hours to obtain [Liquid dispersion 1 of particulate] of a vinyl resin (copolymer of styrene-methacrylic acid-butyl acrylate-sodium salt of sulfuric acid ester of an adduct of methacrylic acid with ethyleneoxide). The volume average particle diameter of the particles disperses in [Liquid dispersion 1 of particulate] was 0.1 μm as measured by lase diffraction/scattering type particle size distribution analyzer (LA-920, manufactured by Horiba Ltd.). Part of [Liquid dispersion 1 of particulate] was taken out. Tg and Mw thereof were 65° C. and 150,000, respectively.

### Manufacturing Example 31

### Manufacturing of Liquid Dispersion 2 of Particulate

500 parts of toluene was placed in a reaction container equipped with a stirrer, a heating and cooling device, a thermometer, a condenser tube, a dripping funnel, and a nitrogen-introducing tube. 350 parts of toluene, 150 parts of behenyl acrylate (Blendmer Va., manufactured by NOF CORPORATION), and 7.5 parts of azobis isobutylonitrile (AIBN) were placed in a glass beaker followed by stirring and mixing at 20° C. to prepare a monomer solution, which was put into the dripping funnel. After nitrogen replacement of the gas phase portion of the reaction container, the monomer solution was dripped at 80° C. in two hours while being sealed. Subsequent to aging at 85° C. for 2 hours after the dripping, toluene was removed at 130° C. under a reduced pressure of from 0.007 MPa to 0.026 MPa for three hours to obtain an acrylic crystalline resin. The resin had a melting point of 65° C. and an Mn of 50,000.

700 parts of n-hexane and 300 parts of the acrylic crystalline resin were mixed and thereafter pulverized by a bead mill (DYNO MILL MULTI LAB, manufactured by WBA Co., Ltd.) using zirconia beads having a particle size of 0.3 mm to obtain milky white [Liquid dispersion 2 of particulate]. This liquid dispersion has a volume average particle diameter of 0.3 μm.

### Manufacturing Example 32

### Manufacturing of Liquid Dispersion of Coloring Agent

557 parts (17.5 mol parts) of propylene glycol, 569 parts (7.0 mol parts) of terephthalic acid dimethyl ester, 184 parts (3.0 mol parts) of adipic acid, and 3 parts of tetrabuthoxy titanate were placed in a reaction container equipped with a stirrer, a heating and cooling device, a thermometer, a condenser tube, and a nitrogen-introducing tube to conduct reaction at 180° C. in a nitrogen atmosphere while distilling away produced methanol. Next, the system was gradually heated to 230° C. to conduct reaction for four hours in a nitrogen atmosphere while distilling away produced water and proplyene glycol followed by one-hour reaction with a reduced pressure of from 0.007 mmHg to 0.026 mmHg. The content of propylene glycol retrieved was 175 parts (5.5 mol parts). After the system was cooled down to 180° C., 121 parts (1.5 mol parts) of trimellitic anhydride was added thereto. Subsequent to two-hour reaction while being sealed, the reaction was continued at 220° C. under normal pressure until the softening point thereof became 180° C. to obtain a polyester resin (Mn=8,500).

20 parts of copper phthalocyanine, 4 parts of coloring agent dispersant (SOLSPERSE® manufactured by Lubrizol Ltd.), 20 parts of the obtained polyester resin, and 56 parts of ethyl acetate were placed in a beaker. These were stirred for even dispersion followed by fine-dispersion of copper phtoalocyanine by a bead mill to obtain a liquid dispersion of coloring agent.

The liquid dispersion of coloring agent has a volume average particle diameter of 0.2 μm as measured by LA-920.

### Manufacturing Example 33

### Manufacturing of Modified Wax

454 parts of xylene and 150 parts of low molecular weight polyethylene (SANWAX LEL-400, softening point: 128° C., manufactured by Sanyo Chemical Industries, Ltd.) were placed in a pressure-tight reaction container equipped with a stirrer, a heating and cooling device, a thermometer, and a dripping cylinder. After nitrogen replacement, the system was heated to 170° C. while being stirred. A liquid mixture of 595 parts of styrene, 255 parts of methyl methacrylate, 34 parts of di-t-butyl peroxyhexahydro terephthalate, and 119 parts of xylene were dripped at the same temperature in three hours and maintained at the same temperature for 30 minutes. Xylene was distilled away under a reduced pressure of 0.039 MPa to obtain a modified wax. The graft chain of the modified wax had an SP of 10.35 (cal/cm³)^{1/2}, an Mn of 1,900, an Mw of 5,200, and a Tg of 56.9° C.

### Manufacturing Example 34

### Manufacturing of Liquid Dispersion of Releasing Agent

10 parts of paraffin wax (HNP-9, melting heat maximum peak temperature: 73° C., manufactured by Nippon Seiro CO., Ltd.), 1 part of the modified wax obtained in Manufacturing Example 33, and 33 parts of etylacetate were placed in a reaction container equipped with a stirrer, a heating and a cooling device, a condenser tube, and a thermometer and heated to 78° C. while being stirred. After being stirred at the same temperature for 30 minutes, the system was cooled down to 30° C. in one hour to crystallize paraffin wax in a particulate manner followed by wet pulverization by ULTRAVISCOMILL™ (manufactured by AIMEX Co., Ltd.) to obtain a liquid dispersion of releasing agent.

The volume particle diameter thereof was 0.25 μm.

### Manufacturing Example 35

### Manufacturing of Resin Solution D-1

30 parts of the liquid dispersion of coloring agent, 140 parts of the liquid dispersion of releasing agent, 100 parts of the binder resin obtained in Manufacturing Example 17, and 153 parts of ethylacetate were placed in a reaction container equipped with a stirrer and a thermometer and thereafter stirred to dissolve the binder resin uniformly to obtain [Resin solution D-1].

### Manufacturing Example 36

### Manufacturing of Resin Solution D-2

30 parts of the liquid dispersion of coloring agent, 140 parts of the liquid dispersion of releasing agent, 100 parts of the binder resin obtained in Manufacturing Example 18, and 153 parts of ethylacetate were placed in a reaction container equipped with a stirrer and a thermometer and thereafter stirred to dissolve the binder resin uniformly to obtain [Resin solution D-2].

### Manufacturing Example 37

### Manufacturing of Resin Solution D-3

30 parts of the liquid dispersion of coloring agent, 140 parts of the liquid dispersion of releasing agent, 100 parts of the binder resin obtained in Manufacturing Example 19, and 153 parts of ethylacetate were placed in a reaction container equipped with a stirrer and a thermometer and thereafter stirred to dissolve the binder resin uniformly to obtain [Resin solution D-3].

### Manufacturing Example 38

### Manufacturing of Resin Solution D-4

30 parts of the liquid dispersion of coloring agent, 140 parts of the liquid dispersion of releasing agent, 100 parts of the binder resin obtained in Manufacturing Example 20, and 153 parts of ethylacetate were placed in a reaction container equipped with a stirrer and a thermometer and thereafter stirred to dissolve the binder resin uniformly to obtain [Resin solution D-4].

### Manufacturing Example 39

### Manufacturing of Resin Solution D-5

30 parts of the liquid dispersion of coloring agent, 140 parts of the liquid dispersion of releasing agent, 100 parts of the binder resin obtained in Manufacturing Example 21, and 153 parts of ethylacetate were placed in a reaction container equipped with a stirrer and a thermometer and thereafter stirred to dissolve the binder resin uniformly to obtain [Resin solution D-5].

### Manufacturing Example 40

### Manufacturing of Resin Solution D-6

30 parts of the liquid dispersion of coloring agent, 140 parts of the liquid dispersion of releasing agent, 100 parts of the binder resin obtained in Manufacturing Example 22, and 153 parts of ethylacetate were placed in a reaction container equipped with a stirrer and a thermometer and thereafter stirred to dissolve the binder resin uniformly to obtain [Resin solution D-6].

### Manufacturing Example 41

### Manufacturing of Resin Solution D-7

30 parts of the liquid dispersion of coloring agent, 140 parts of the liquid dispersion of releasing agent, 100 parts of the binder resin obtained in Manufacturing Example 23, and 153 parts of ethylacetate were placed in a reaction container equipped with a stirrer and a thermometer and thereafter stirred to dissolve the binder resin uniformly to obtain [Resin solution D-7].

### Manufacturing Example 42

### Manufacturing of Resin Solution D-8

30 parts of the liquid dispersion of coloring agent, 140 parts of the liquid dispersion of releasing agent, 100 parts of the binder resin obtained in Manufacturing Example 24, and 153 parts of ethylacetate were placed in a reaction container equipped with a stirrer and a thermometer and thereafter stirred to dissolve the binder resin uniformly to obtain [Resin solution D-8].

### Manufacturing Example 43

### Manufacturing of Resin Solution D-9

30 parts of the liquid dispersion of coloring agent, 140 parts of the liquid dispersion of releasing agent, 100 parts of the binder resin obtained in Manufacturing Example 25, and 153 parts of ethylacetate were placed in a reaction container equipped with a stirrer and a thermometer and thereafter stirred to dissolve the binder resin uniformly to obtain [Resin solution D-9].

### Manufacturing Example 44

### Manufacturing of Resin Solution D-10

30 parts of the liquid dispersion of coloring agent, 140 parts of the liquid dispersion of releasing agent, 100 parts of the binder resin obtained in Manufacturing Example 26, and 153 parts of ethylacetate were placed in a reaction container equipped with a stirrer and a thermometer and thereafter stirred to dissolve the binder resin uniformly to obtain [Resin solution D-10].

### Manufacturing Example 45

### Manufacturing of Resin Solution D′-1

30 parts of the liquid dispersion of coloring agent, 140 parts of the liquid dispersion of releasing agent, 100 parts of the binder resin obtained in Manufacturing Example 27, and 153 parts of ethylacetate were placed in a reaction container equipped with a stirrer and a thermometer and thereafter stirred to dissolve the binder resin uniformly to obtain [Resin solution D′-1].

### Manufacturing Example 46

### Manufacturing of Resin Solution D′-2

30 parts of the liquid dispersion of coloring agent, 140 parts of the liquid dispersion of releasing agent, 100 parts of the binder resin obtained in Manufacturing Example 28, and 153 parts of ethylacetate were placed in a reaction container equipped with a stirrer and a thermometer and thereafter stirred to dissolve the binder resin uniformly to obtain [Resin solution D′-2].

### Manufacturing Example 47

### Manufacturing of Resin Solution D′-3

30 parts of the liquid dispersion of coloring agent, 140 parts of the liquid dispersion of releasing agent, 100 parts of the binder resin obtained in Manufacturing Example 29, and 153 parts of ethylacetate were placed in a reaction container equipped with a stirrer and a thermometer and thereafter stirred to dissolve the binder resin uniformly to obtain [Resin solution D′-3].

The compositions of [Resin solution D-1] to [Resin solution D-10] and [Resin solution D′-1] to [Resin solution D′-3] obtained in Manufacturing Examples 35 to 47 are shown in Table 4.

TABLE 4

| | | Resin solution | | | | | | |
|---|---|---|---|---|---|---|---|---|
| | | D-1 | D-2 | D-3 | D-4 | D-5 | D-6 | D-7 |
| Liquid dispersion | | 30 | 30 | 30 | 30 | 30 | 30 | 30 |
| of coloring agent | | | | | | | | |
| Liquid dispersion | | 140 | 140 | 140 | 140 | 140 | 140 | 140 |
| of releasing agent | | | | | | | | |
| Binder | R-3 | 100 | — | — | — | — | — | — |
| resin | R-4 | — | 100 | — | — | — | — | — |
| | R-5 | — | — | 100 | — | — | — | — |
| | R-6 | — | — | — | 100 | — | — | — |
| | R-7 | — | — | — | — | 100 | — | — |
| | R-8 | — | — | — | — | — | 100 | — |
| | R-9 | — | — | — | — | — | — | 100 |
| | R-10 | — | — | — | — | — | — | — |
| | R-11 | — | — | — | — | — | — | — |
| | R-12 | — | — | — | — | — | — | — |
| | R′-1 | — | — | — | — | — | — | — |
| | R′-2 | — | — | — | — | — | — | — |
| | R′-3 | — | — | — | — | — | — | — |

| | | | | | | | |
|---|---|---|---|---|---|---|---|
| Ethylacetate | 153 | 153 | 153 | 153 | 153 | 153 | 153 |

| | | Resin solution | | | | | |
|---|---|---|---|---|---|---|---|
| | | D-8 | D-9 | D-10 | D′-1 | D′-2 | D′-3 |
| Liquid dispersion | | 30 | 30 | 30 | 30 | 30 | 30 |
| of coloring agent | | | | | | | |
| Liquid dispersion | | 140 | 140 | 140 | 140 | 140 | 140 |
| of releasing agent | | | | | | | |
| Binder | R-3 | — | — | — | — | — | — |
| resin | R-4 | — | — | — | — | — | — |
| | R-5 | — | — | — | — | — | — |
| | R-6 | — | — | — | — | — | — |
| | R-7 | — | — | — | — | — | — |
| | R-8 | — | — | — | — | — | — |
| | R-9 | — | — | — | — | — | — |
| | R-10 | 100 | — | — | — | — | — |
| | R-11 | — | 100 | — | — | — | — |
| | R-12 | — | — | 100 | — | — | — |
| | R′-1 | — | — | — | 100 | — | — |
| | R′-2 | — | — | — | — | 100 | — |
| | R′-3 | — | — | — | — | — | 100 |

| | | | | | | |
|---|---|---|---|---|---|---|
| Ethylacetate | 153 | 153 | 153 | 153 | 153 | 153 |

Manufacturing Example 48: Preparation of Solution of Precursor b0-1

681 parts of an adduct of bisphenol A with 2 mols of EO, 81 parts of bisphenol A with 2 mols of PO, 275 parts of terephthalic acid, 7 parts of adipic acid, 22 parts of trimellitic anhydride, 2 parts of dibutyl tin oxide were placed in a reaction container equipped with a stirrer, a heating and a cooling device, a nitrogen introducing tube, and a thermometer to conduct dehydration reaction at 230° C. under normal pressure for five hours followed by another five-hour dehydration reaction under a reduced pressure of from 0.01 MPa to 0.03 MPa to obtain a polyester resin.

50 parts of the polyethylene resin, 50 parts of isophorone diisocyanate, 600 parts of ethyl acetate, and 0.5 parts of deionized water were placed in a pressure-tight reaction container equipped with a stirrer, a heating and a cooling device, and a thermometer to conduct reaction at 90° C. for five hours in a sealed state to obtain [Precursor b0-1] having an isocyanate group at its molecular end. [Precursor b0-1] had a urethane group concentration of 5.2% by weight and a urea group concentration of 0.3% by weight. The solid portion concentration was 45% by weight.

### Example 1

### Manufacturing of Toner S-1

100 parts of [Binder resin R-1], 8 parts of carbon black (MA-100, manufactured by Mitsubishi Chemical Corporation), 8 parts of carnauba wax, and 1 part of a charge control agent (T-77, manufactured by HODOGAYA CHEMICAL CO., LTD.) were preliminarily mixed by a HENSCHEL MIXER (FM10B, manufactured by NIPPON COKE & ENGINEERING CO., LTD.) followed by mixing and kneading by a twin shaft kneader (PCM-30, manufactured by IKEGAI CORPORATION). Thereafter, the resultant was finely-pulverized by a supersonic jet pulverizer (Labojet, manufactured by NIPPON PNEUMATIC MFG CO., LTD.) followed by classification by an air classifier (MDS-I, manufactured by NIPPON PNEUMATIC MFG CO., LTD.) to obtain toner particles having a D50 of 8 μm. Thereafter, 0.5 parts of colloidal silica (AEROSIL® R972, manufactured by NIPPON AEROSIL CO., LTD.) was admixed with 100 parts of the toner particle by a SampleMill to obtain [Toner S-1] of the present disclosure.

### Example 2

### Manufacturing of Toner S-2

[Toner S-1] of the present disclosure was obtained in the same manner as in Example 1 except that 100 parts of [Binder resin R-1] was changed to 100 parts of [Binder resin R-2].

### Example 3

### Manufacturing of Toner S-3

170.2 parts of deionized water, 0.3 parts of [Liquid dispersion 1 of particulate], 1 part of carboxymethyl cellulose sodium, 36 parts of 48.5% by weight aqueous solution of dodecyl diphenylether sodium disulfonate (EREMINOR MON-7, manufactured by Sanyo Chemical Industries, Ltd.), and 15.3 parts of ethyl acetate were placed in a beaker followed by stirring to dissolve them uniformly. Thereafter, the system was heated to 50° C. and 75 parts of [Resin solution D-1] was added thereto at the same temperature while being stirred by a TK HOMOMIXER at 10,000 rotation per minute (rpm) for two minutes. Next, this liquid mixture was transferred to a reaction container equipped with a stirrer and a thermometer followed by distilling away ethyl acetate at 50° C. until the concentration thereof became 0.5% by weight or less to obtain an aqueous resin dispersion element of toner particle. Subsequent to washing and filtration of the aqueous resin dispersion element of toner particle, the resultant was dried at 40° C. for 18 hours until the volatile portions became 0.5% or less to obtain toner particles. Thereafter, 0.05 parts of colloidal silica (AEROSIL® R972, manufactured by NIPPON AEROSIL CO., LTD.) was admixed with 10 parts of the toner particle by a SampleMill to obtain [Toner S-3] of the present disclosure.

### Example 4

### Manufacturing of Toner S-4

[Toner S-4] of the present disclosure was obtained in the same manner as in Example 3 except that 75 parts of [Resin solution D-1] was changed to 75 parts of [Resin solution D-2].

### Example 5

### Manufacturing of Toner S-5

[Toner S-5] of the present disclosure was obtained in the same manner as in Example 3 except that 75 parts of [Resin solution D-1] was changed to 75 parts of [Resin solution D-3].

### Example 6

### Manufacturing of Toner S-6

[Toner S-6] of the present disclosure was obtained in the same manner as in Example 3 except that 75 parts of [Resin solution D-1] was changed to 75 parts of [Resin solution D-4].

### Example 7

### Manufacturing of Toner S-7

[Toner S-7] of the present disclosure was obtained in the same manner as in Example 3 except that 75 parts of [Resin solution D-1] was changed to 75 parts of [Resin solution D-5].

### Example 8

### Manufacturing of Toner S-8

[Toner S-8] of the present disclosure was obtained in the same manner as in Example 3 except that 75 parts of [Resin solution D-1] was changed to 75 parts of [Resin solution D-6].

### Example 9

### Manufacturing of Toner S-9

108 parts of decane and 2.1 parts of [Liquid dispersion 2 of particulate] were placed in a beaker and stirred for uniform dissolution. Thereafter, the system was heated to 50° C. and 75 parts of [Resin solution D-7] was added thereto at the same temperature while being stirred by a TK HOMOMIXER at 10,000 rotation per minute (rpm) for two minutes. Next, this liquid mixture was transferred to a reaction container equipped with a stirrer and a thermometer followed by distilling away ethyl acetate at 50° C. until the concentration thereof became 0.5% by weight or less. Subsequent to washing and filtration, the resultant was dried at 40° C. for 18 hours until the volatile portions became 0.5% or less to obtain toner particles. Thereafter, 0.05 parts of colloidal silica (AEROSIL® R972, manufactured by NIPPON AEROSIL CO., LTD.) was admixed with 10 parts of the toner particle by a SampleMill to obtain [Toner S-9] of the present disclosure.

### Example 10

### Manufacturing of Toner S-10

[Toner S-10] of the present disclosure was obtained in the same manner as in Example 9 except that 75 parts of [Resin solution D-7] was changed to 75 parts of [Resin solution D-8].

### Example 11

### Manufacturing of Toner S-11

[Toner S-11] of the present disclosure was obtained in the same manner as in Example 9 except that 75 parts of [Resin solution D-7] was changed to 75 parts of [Resin solution D-9].

### Example 12

### Manufacturing of Toner S-12

[Toner S-12] of the present disclosure was obtained in the same manner as in Example 9 except that 75 parts of [Resin solution D-7] was changed to 75 parts of [Resin solution D-10].

### Example 13

### Manufacturing of Toner S-13

170.2 parts of deionized water, 0.3 parts of [Liquid dispersion 1 of particulate], 1 part of carboxymethyl cellulose sodium, 36 parts of 48.5% by weight aqueous solution of dodecyl diphenylether sodium disulfide (EREMINOR MON-7, manufactured by Sanyo Chemical Industries, Ltd.), and 15.3 parts of ethyl acetate were placed in a beaker followed by stirring to dissolve them uniformly. Thereafter, 11.2 parts of [Precursor B0-1], 5.5 parts of [Curing agent β-1], and 63.8 parts of [Resin solution D-9] were placed in a TK HOMOMIXER and stirred at 10,000 rpm for two minutes. Next, this liquid mixture was transferred to a reaction container equipped with a stirrer, heating and cooling device, a condenser tube, and a thermometer followed by distilling away ethyl acetate at 50° C. until the concentration thereof became 0.5% by weight or less to obtain an aqueous resin dispersion element of toner particle. Subsequent to washing and filtration of the aqueous resin dispersion element of toner particle, the resultant was dried at 40° C. for 18 hours until the volatile portions became 0.5% or less to obtain [Toner S-13] of the present disclosure.

### Example 14

### Manufacturing of Toner S-14

[Toner S-14] of the present disclosure was obtained in the same manner as in Example 13 except that 75 parts of [Resin solution D-7] was changed to 75 parts of [Resin solution D-10].

### Comparative Example 1

### Manufacturing of Toner S′-1

[Toner S′-1] of the present disclosure was obtained in the same manner as in Example 3 except that 75 parts of [Resin solution D-1] was changed to 75 parts of [Resin solution D′-1].

### Comparative Example 2

### Manufacturing of Toner S′-2

[Toner S′-2] of the present disclosure was obtained in the same manner as in Example 3 except that 75 parts of [Resin solution D-1] was changed to 75 parts of [Resin solution D′-2].

### Comparative Example 3

### Manufacturing of Toner S′-3

[Toner S′-3] of the present disclosure was obtained in the same manner as in Example 3 except that 75 parts of [Resin solution D-1] was changed to 75 parts of [Resin solution D′-3].

The volume average particle diameters and the particle size distributions of [Toner S-1] to [Toner S-14] and [Toner S′-1] to [Toner S′-3] were measured by the following method to evaluate the high temperature stability, the low temperature fixability, the hot offset resistance, and the blocking resistance thereof. The results are shown in Table 5.

1: Volume Average Particle Diameter and Particle Size Distribution

[Toner S-1] to [Toner S-14] and [Toner S′-1] to [Toner S′-3] were dispersed in water to measure D50 and the particle size distribution by Coulter Counter (Multisizer III, manufactured by Beckman Coulter Inc.).

2. High Temperature Stability

[Toner S-1] to {Toner S-14] and [Toner S′-1] to [Toner S′-3] were stood still in an atmosphere of 40° C. to visually confirm the degree of blocking followed by evaluation of the high temperature stability thereof according to the following criteria:

Evaluation Criteria

G (Good): No blocking confirmed
B (Bad): Blocking confirmed

3. Low Temperature Fixability

[Toner S-1] to [Toner S-14] and [Toner S′-1] to [Toner S′-3] were placed on paper uniformly to be 0.6 mg/cm² (a printer from which a thermal fixing device was removed was used. Any method that can uniformly place toner powder at the same weight density is suitable.) The temperature (MFT) at which cold offset occurred was measured when this paper was passed through the pressing roller at a fixing speed (peripheral speed of the heating roller) of 213 mm/s and a fixing pressure (pressure by the pressure roller) of 10 kg/cm². The lower the temperature is, the more excellent low temperature fixability temperature the toner has.

4. Hot Offset Resistance

The toner was evaluated in the same manner as for the low temperature fixiability. Whether hot offset of a fixed image occurred was evaluated by visual confirmation. The upper limit temperature above hot offset occurred after passing through the fixing roller was defined as hot offset occurring temperature (HOT) and the difference between HOT and MFT was defined as the fixing temperature range. The larger the fixing temperature range is, the more excellent hot offset resistance the toner has.

5. Blocking Resistance

Using the fixed image when evaluating the low temperature fixability of toner, the image portion was overlapped facing the non-image portion and the image portion. While a weight corresponding to 80 g/cm² was applied to the overlapped portion, the overlapped portion was left in a constant temperature and humidity at 55° C. and 50% RH for one day. Thereafter, the degree of image deficiency of the two overlapped fixed images were visually confirmed and evaluated about blocking resistance according to the following criteria:

Evaluation Criteria

G (Good): No image transfer confirmed at both non-image portion and image portion
B (Bad): Two printed matters were attached to each other and imaged deficiency was severe to a degree that the surface layer of the paper was peeled off together when forcibly detached.

TABLE 5

| | Example 1 | Example 2 | Example 3 | Example 4 | Example 5 |
|---|---|---|---|---|---|
| Resin | S-1 | S-2 | S-3 | S-4 | S-5 |
| particle | | | | | |
| Volume | 8.0 | 8.0 | 6.0 | 4.0 | 5.0 |
| average | | | | | |
| particle | | | | | |
| diameter | | | | | |
| (μm) | | | | | |
| Particle size | 1.25 | 1.22 | 1.11 | 1.16 | 1.16 |
| distribution | | | | | |
| High | G | G | G | G | G |
| temperature | | | | | |
| stability | | | | | |
| Low | 110 | 100 | 90 | 100 | 100 |
| temperature | | | | | |
| fixability | | | | | |
| (° C.) | | | | | |
| Hot offset | 200 | 200 | 200 | 200 | 200 |
| resistance | | | | | |
| (° C.) | | | | | |
| Block | G | G | G | G | G |
| resistance of | | | | | |
| sheet | | | | | |
| | | | | | Example |
| | Example 6 | Example 7 | Example 8 | Example 9 | 10 |
| Resin | S-6 | S-7 | S-8 | S-9 | S-10 |
| particle | | | | | |
| Volume | 5.2 | 6.0 | 6.0 | 5.5 | 5.4 |
| average | | | | | |
| particle | | | | | |
| diameter | | | | | |
| (μm) | | | | | |
| Particle size | 1.18 | 1.13 | 1.15 | 1.12 | 1.17 |
| distribution | | | | | |
| High | G | G | G | G | G |
| temperature | | | | | |
| stability | | | | | |
| Low | 100 | 95 | 105 | 105 | 110 |
| temperature | | | | | |
| fixability | | | | | |
| (° C.) | | | | | |
| Hot offset | 200 | 200 | 200 | 200 | 200 |
| resistance | | | | | |
| (° C.) | | | | | |
| Block | G | G | G | G | G |
| resistance of | | | | | |
| sheet | | | | | |
| | | | | | Com- |
| | Example | Example | Example | Example | parative |
| | 11 | 12 | 13 | 14 | Example 1 |
| Resin | S-11 | S-12 | S-13 | S-14 | S′-1 |
| particle | | | | | |
| Volume | 5.4 | 5.3 | 5.1 | 5.2 | 8.0 |
| average | | | | | |
| particle | | | | | |
| diameter | | | | | |
| (μm) | | | | | |
| Particle size | 1.13 | 1.12 | 1.11 | 1.13 | 1.50 |
| distribution | | | | | |
| High | G | G | G | G | B |
| temperature | | | | | |
| stability | | | | | |
| Low | 105 | 95 | 105 | 110 | 150 |
| temperature | | | | | |
| fixability | | | | | |
| (° C.) | | | | | |
| Hot offset | 200 | 200 | 200 | 200 | 200 |
| resistance | | | | | |
| (° C.) | | | | | |
| Block | G | G | G | G | B |
| resistance of | | | | | |
| sheet | | | | | |

| | Comparative | Comparative |
|---|---|---|
| | Example 2 | Example 3 |
| Resin | S′-2 | S′-3 |
| particle | | |
| Volume | 6.0 | 7.0 |
| average | | |
| particle | | |
| diameter | | |
| (μm) | | |
| Particle size | 1.40 | 1.54 |
| distribution | | |
| High | B | G |
| temperature | | |
| stability | | |
| Low | 140 | 140 |
| temperature | | |
| fixability | | |
| (° C.) | | |
| Hot offset | 200 | 200 |
| resistance | | |
| (° C.) | | |
| Block | B | B |
| resistance of | | |
| sheet | | |

As described above, according to the present invention, toner having good low temperature fixability, high temperature stability, and hot offset resistance is provided which has also excellent blocking resistance of sheets in continuous printing mode.

Having now fully described embodiments of the present invention, it will be apparent to one of ordinary skill in the art that many changes and modifications can be made thereto without departing from the spirit and scope of embodiments of the invention as set forth herein.

What is claimed is:

1. Toner comprising:
a binder resin comprising two or more kinds of crystalline resins; and
a coloring agent,
wherein the two or more kinds of crystalline resins have at least two endothermic peak temperatures in a set of endothermic peak temperatures of the two or more kinds of crystalline resins as measured by differential scanning calorimetry (DSC).

2. The toner according to claim 1, wherein the highest endothermic peak temperature and the lowest endothermic peak temperature of the set of endothermic peak temperatures has a difference of from 3° C. to 40° C.

3. The toner according to claim 1, wherein each of the two or more kinds of crystalline resins has an endothermic peak temperature of from 40° C. to 120° C.

4. The toner according to claim 1, wherein, the two or more kinds of crystalline resins satisfy the following relation in measuring of viscoelasticity of a mixture of the two or more kinds of crystalline resins:
0° C.<Tup−Tdown≦30° C.,
where Tup represents a temperature at which the two or more kinds of crystalline resins have a storage elastic modulus of 1.0×10⁶ Pa at a temperature rising rate of 10° C./minute from 30° C. and Tdown represents a temperature at which the two or more kinds of crystalline resins have a storage elastic modulus of 1.0×10⁶ Pa at a temperature falling rate of 10° C./minute from a temperature of Tup+20° C.

5. The toner according to claim 1, wherein at least one of the two or more kinds of crystalline resins is a resin comprising a crystalline portion and a urethane bond.

6. The toner according to claim 5, wherein the crystalline portion is derived from a resin selected from the group consisting of a crystalline polyeyster resin, a crystalline polyurethane resin, a crystalline polyurea resin, a crystalline vinyl resin, a crystalline epoxy resin, a crystalline polyether resin, and a complex resin thereof.

7. The toner according to claim 1, wherein at least one of the two or more kinds of crystalline resins is a resin comprising a crystalline portion with no non-crystalline portion.

8. The toner according to claim 1, wherein at least one of the two or more kinds of crystalline resins is a block resin comprising a crystalline portion and a non-crystalline portion.

9. The toner according to claim 8, wherein a content ratio of the crystalline portion is 50% by weight to 99% by weight based on a mass of the two or more kinds of crystalline resins.

10. The toner according to claim 1, wherein the two or more kinds of crystalline resins account for 51% by weight or more of a mass of the binder resin.
